(19) United States
(12) Patent Application Publication
(10) Pub. No.: US 2008/0091776 A1
(43) Pub. Date: Apr. 17, 2008

(54) Information processing apparatus and information processing system

(76) Inventor: Hiroki Miyamoto, Fujisawa (JP)

Correspondence Address: MCDERMOTT WILL & EMERY LLP, 600 13TH STREET, N.W., WASHINGTON, DC, 20005-3096, US

(21) Appl. No.: 11/890,550

(22) Filed: Aug. 7, 2007

(30) Foreign Application Priority Data
Aug. 8, 2006 (JP) 2006-215338

(51) Int. Cl. G06F 15/16; G06F 17/30

(52) U.S. Cl. 709/203; 707/100

(57) ABSTRACT

By linking an information processing apparatus which is newly added/connected to a communication network with an existing information processing apparatus, a more advantageous service can be provided, a system is arranged as follows: An information processing apparatus 9 contains a processing program 23 which corresponds to a predetermined process operation executed by each unit. An initiation/stop of the processing program 23 are also controlled based upon a command outputted from a home server 3 to the information processing apparatus 9. Since the processing program 23 is initiated, a service specific to the information processing apparatus 9 is provided as a network service to client programs (31, 33, 35) of the home server 3 from the information processing apparatus 9. The information processing apparatus 9 also contains an apparatus structural table 25.

### INCORPORATION BY REFERENCE

The present application claims priority from Japanese application JP 2006-215338 filed on Aug. 8, 2006, the content of which is hereby incorporated by reference into this application.

### BACKGROUND OF THE INVENTION

The present invention relates to an information processing apparatus which is newly connected to a communication network to which a plurality of information processing apparatuses have been connected, and also related to an information processing system equipped with a plurality of information processing apparatuses which have been connected to each other via a communication network, and equipped with an information processing apparatus which is newly connected to the above-described communication network.

### TECHNICAL BACKGROUND

Conventionally, application program management systems and application program managing methods have been proposed, while these application program management systems and methods have purposes capable of dynamically expanding functions of controllable apparatuses by continuously updating the application programs for these controllable apparatuses under home network environments. In these proposed ideas, middleware such as UPnP (Universal Plug and Play) and Jini (registered trademark of Sun Microsystems) has been utilized. In other words, since UPnP, Jini, or the like is utilized, a detection is made whether or not an information processing apparatus is newly added/connected to a home network where an application program server (for example, home server) is located. Also, since OSGi (Open Services Gateway Initiative) is utilized, an application program for utilizing the added new information processing apparatus is downloaded (refer to, for example, JP-A-2004-213612 corresponding to US 2004/0139177A1).

Further, currently, a large number of technical ideas have been proposed which may provide services to users by linking a plurality of apparatuses to each other by utilizing UPnP, or Jini. As one example of these proposed technical ideas, in the UPnP-AV architecture utilized in DLNA (Digital Living Network Alliance), a user can utilize functions of plural servers by operating one client. Such a technical idea has been disclosed in, for example, OSGi Technology (http://www.osgi.org/osgi technology/index.asp?section=2) of OSGi Alliance.

### SUMMARY OF THE INVENTION

In the application program management system and method related to the above-described proposed technical idea (JP-A-2004-213612), as previously explained, since UPnP, Jini, or the like is utilized, the detection is made whether or not the information processing apparatus is newly added/connected to the home network. Also, since OSGi is utilized, the application program for utilizing the information processing apparatus can be downloaded with respect to the newly added/connected information processing apparatus.

On the other hand, in the system related to the proposed technical idea of the OSGi Technology, namely, in the UPnP-AV architecture utilized in the above-explained DLNA, as previously explained, since the plural servers are linked to each other, the user can utilize functions of plural servers by merely operating one client.

However, in the above-described conventional techniques, it is practically difficult to provide such a new service to a user, while this new service is obtained by coupling the service realized by the newly added/connected information processing apparatus by cooperating this information processing apparatus newly added/connected to the home network with such an information processing apparatus which has been previously present on the home network from the beginning, with the service realized by the existing information processing apparatus. Also, in the above-described conventional techniques, every time an information processing apparatus is newly added/connected to a home network, a new control protocol must be installed in all of information processing apparatuses on the home network. As a result, there are problems of a lower efficiency and higher cost.

As a consequence, if the function held by the information processing apparatus which is newly added/connected to the home network is linked to the function held by the existing information processing apparatus in an organic manner, then a more advantageous service may be provided to users. However, it is practically difficult to provide such a more advantageous service.

As a consequence, an object of the present invention is to achieve that an information processing apparatus which is newly added/connected to a communication network can be readily linked to another information processing apparatus which has been previously present on the communication network.

An other object of the present invention is to achieve that a more advantageous service can be provided to a user, since an information processing apparatus which is newly added/connected to a communication network is linked to another information processing apparatus which has been previously present on the communication network.

An information processing apparatus, according to a first aspect of the present invention, is featured by such an information processing apparatus which is newly connected to a communication network to which a plurality of information processing apparatuses have been connected, and is comprised of: a retrieving unit having attribute information related to the information processing apparatus itself and attribute information related to the plurality of information processing apparatuses, for retrieving the plurality of information processing apparatuses; an information processing apparatus management information forming unit for forming information processing apparatus management information based upon a retrieved result of the plurality of information processing apparatuses by the retrieving unit and also the attribute information related to the plurality of information processing apparatuses, the information processing apparatus management information containing a combination of such information processing apparatuses capable of providing an upper grade service which is higher than services separately provided from the respective information processing apparatuses by linking the respective information processing apparatuses; and an initiation command selecting/outputting unit for selecting an information processing apparatus which is required so as to provide a service from the information processing apparatus management information formed by the information processing apparatus management information forming unit by receiving a service request issued from a user, the provided service corresponding to the service request, and for outputting an initiation command with respect to the selected information processing apparatus.

In an appropriate embodiment related to the first aspect of the present invention, when the information processing apparatus itself is connected to the communication network, or another information processing apparatus is connected to the communication network, the retrieving unit retrieves all of the information processing apparatuses which have been connected to the communication network.

In another embodiment different from the above-described embodiment, when the information processing apparatus itself is connected to the communication network, or another information processing apparatus is connected to the communication network, the information processing apparatus management information forming unit forms the information processing apparatus management information.

Also, in another embodiment different from the above-described embodiment, the information processing apparatus management information is formed by applying identification information which have been previously and separately allocated to all of the information processing apparatuses to be connected to the communication network to the attribute information.

Also, in another embodiment different from the above-described embodiment, all of the information processing apparatuses connected to the communication network contains a processing program used to execute a service in response to the service request issued from the user.

Also, in another embodiment different from the above-described embodiment, the information processing apparatus is further comprised of: a judging unit for judging whether or not a plurality of information processing apparatus capable of providing the same service are present among the plurality of information processing apparatuses connected to the communication network, and also, for judging whether or not plural combinations of the information processing apparatuses capable of providing the same service and capable of providing different service are present; and an information processing apparatus management information correcting unit by which when the judging unit judges that the information processing apparatuses and the combinations of the information processing apparatuses are present, the information processing apparatus management information formed by the information processing apparatus management information forming unit is corrected as an information processing apparatus management information to which grouping of the respective combinations are reflected; in which upon receipt of the service request issued from the user and a group designation command issued from the user, the initiation command selecting/outputting unit selects an information processing apparatus required for providing the service corresponding to the service request from the corrected information processing apparatus management information, and outputs an initiation command with respect to the selected information processing apparatus.

Moreover, in a further embodiment different from the above-described embodiment, the correction of the information processing apparatus management information by the information processing apparatus management information correcting unit includes that identification information which can be identified by the user is applied with respect to each of the grouped combinations.

An information processing system, according to a second aspect of the present invention, is featured by comprising: a plurality of information processing apparatuses which have been connected to each other via a communication network; and an information processing apparatus which is newly connected to the communication network; in which the information processing apparatus which is newly connected thereto is comprised of: a retrieving unit having attribute information related to the information processing apparatus itself which is newly connected and attribute information related to the plurality of information processing apparatuses, for retrieving the plurality of information processing apparatuses; an information processing apparatus management information forming unit for forming information processing apparatus management information based upon a retrieved result of the plurality of information processing apparatuses by the retrieving unit and also the attribute information related to the plurality of information processing apparatuses, the information processing apparatus management information containing a combination of such information processing apparatuses capable of providing an upper grade service which is higher than services separately provided from the respective information processing apparatuses by linking the respective information processing apparatuses; and an initiation command selecting/outputting unit for selecting an information processing apparatus which is required so as to provide a service from the information processing apparatus management information formed by the information processing apparatus management information forming unit by receiving a service request issued from a user, the provided service corresponding to the service request, and for outputting an initiation command with respect to the selected information processing apparatus.

In an appropriate embodiment related to the second aspect of the present invention, the communication network is a home network; and the information processing apparatus is further comprised of a home server which instructs each of the information processing apparatuses to provide a service desired by the user, and is connected to the home network.

In another embodiment different from the above-described embodiment, the home server is comprised of: a retrieving unit for retrieving the attribute information related to the plurality of information processing apparatuses and the plurality of information processing apparatuses; an information processing apparatus management information forming unit for forming information processing apparatus management information based upon a retrieved result of the plurality of information processing apparatuses by the retrieving unit and also the attribute information related to the plurality of information processing apparatuses, the information processing apparatus management information containing a combination of such information processing apparatuses capable of providing an upper grade service which is higher than services separately provided from the respective information processing apparatuses by linking the respective information processing apparatuses; and an initiation command selecting/outputting unit for selecting an information processing apparatus which is required so as to provide a service from the information processing apparatus management information formed by the information processing apparatus management information forming unit by receiving a service request issued from a user, the provided service corresponding to the service request, and for outputting an initiation command with respect to the selected information processing apparatus.

Also, in another embodiment different from the above-explained embodiment, the home server is comprised of: a judging unit for judging whether or not a plurality of information processing apparatus capable of providing the same service are present among the plurality of information processing apparatuses connected to the communication network, and also, for judging whether or not plural combinations of the information processing apparatuses capable of providing the same service and capable of providing different services are present; and an information processing apparatus management information correcting unit by which when the judging unit judges that the information processing apparatuses and the combinations of the information processing apparatuses are present, the information processing apparatus management information formed by the information processing apparatus management information forming unit is corrected as an information processing apparatus management information to which grouping of the respective combinations are reflected; in which upon receipt of the service request issued from the user and a group designation command issued from the user, the initiation command selecting/outputting unit selects an information processing apparatus required for providing the service corresponding to the service request from the corrected information processing apparatus management information, and outputs an initiation command with respect to the selected information processing apparatus.

Moreover, in a further embodiment different from the above-described embodiment, the correction of the information processing apparatus management information by the information processing apparatus management information correcting unit includes that identification information which can be identified by the user is applied with respect to each of the grouped combinations.

In accordance with the present invention, the information processing apparatus which is newly added/connected to the communication network can be readily linked to the information processing apparatus which has already been present on the communication network.

Also, in accordance with the present invention, since the information processing apparatus which is newly added/connected to the communication network is linked to the information processing apparatus which has already been present on the communication network, a more advantageous service can be provided to the user.

Other objects, features and advantages of the invention will become apparent from the following description of the embodiments of the invention taken in conjunction with the accompanying drawings.

### BRIEF DESCRIPTION OF THE DRAWINGS

FIG. 1 is a functional block diagram for representing an example as to an entire arrangement of an information processing system according to a first embodiment of the present invention.

FIG. 2 is a functional block diagram for showing an example as to an internal arrangement of an information processing apparatus equipped within the information processing system according to the first embodiment of the present invention.

FIG. 3 is a functional block diagram for indicating an example as to an internal arrangement of a home server provided in the information processing system according to the first embodiment of the present invention.

FIG. 4 is an explanatory diagram for showing an example as to an apparatus structural table according to the first embodiment of the present invention.

FIG. 5 is an explanatory diagram for indicating an example as to a structure when the apparatus structural table described in FIG. 4 is stored in either an information processing apparatus or a home server.

FIG. 6 is an explanatory diagram for indicating an example as to an apparatus management table according to the first embodiment of the present invention.

FIG. 7 is a flow chart for describing process sequences executed when the apparatus structural table is installed from the information processing apparatus to the home server in the information processing system according to the first embodiment of the present invention.

FIG. 8 is a flow chart for describing process sequences executed when a client program and an application program, according to the first embodiment of the present invention, are installed in the home server.

FIG. 9 is a flow chart for describing an example of processing operations of the application program initiated on the home server according to the first embodiment of the present invention.

FIG. 10 is an explanatory diagram for representing an example as to a screen displayed on a display unit of a mobile terminal (mobile apparatus) provided in an information processing system according to a second embodiment of the present invention.

FIG. 11 is an explanatory diagram for showing an example of an apparatus structural table according to the second embodiment of the present invention.

FIG. 12 is a flow chart for representing process sequences executed when a user receives a provision of a theater service from the information processing system according to the second embodiment of the present invention.

FIG. 13 is an explanatory diagram for showing an example as to an apparatus structural table according to a third embodiment of the present invention.

FIG. 14 is an explanatory diagram for representing an example as to a screen displayed on a display unit of a mobile terminal (mobile apparatus) provided in an information processing system according to the third embodiment of the present invention.

FIG. 15 is a schematic diagram for indicating an example as to a corresponding relationship among respective information processing apparatuses with respect to monitoring services when the monitoring services according to the third embodiment of the present invention are executed.

FIG. 16 is a flow chart for describing process sequences executed when the user receives a provision of a monitoring service from the information processing system according to the third embodiment of the present invention.

### DESCRIPTION OF THE EMBODIMENTS

Referring now to drawings, embodiments of the present invention will be described in more detail.

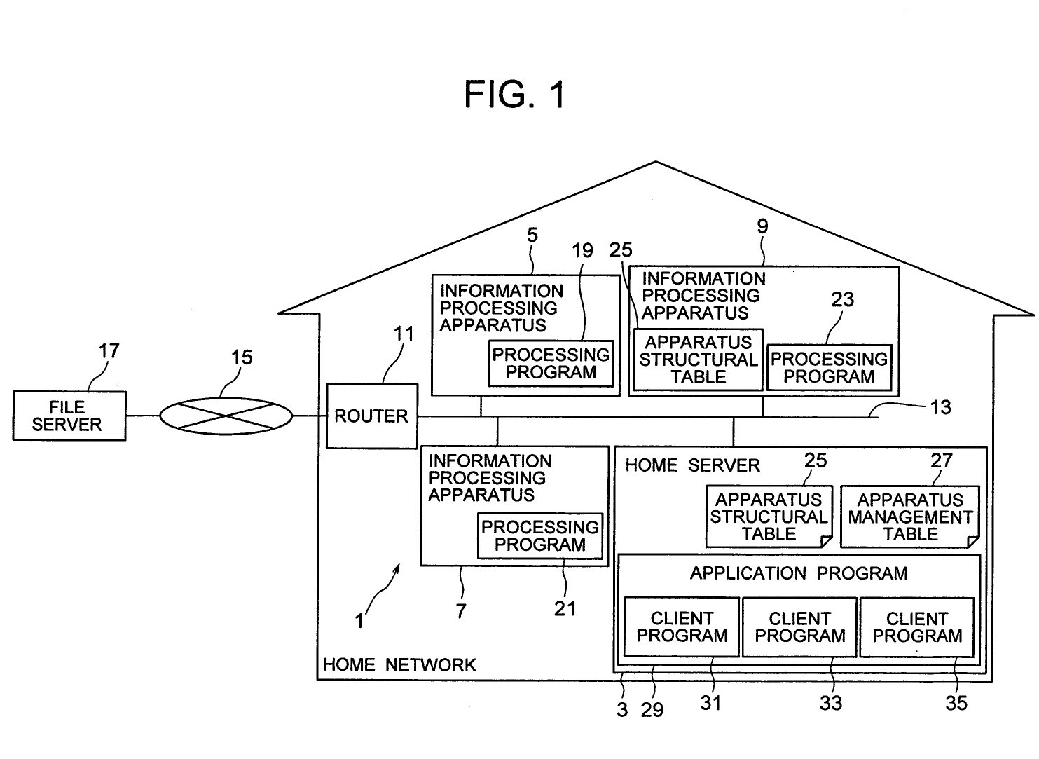

FIG. 1 is a functional block diagram for representing an example as to an entire arrangement of an information processing system according to a first embodiment of the present invention. In this first embodiment, the above-described information processing system is arranged by a home network constructed in a home, and an external information processing apparatus (external server). The external information processing apparatus is connected via a communication network such as the Internet to the home network.

In FIG. 1, a home network 1 has been arranged by that a plurality of various sorts of apparatuses (will be referred to as “information processing apparatuses”, hereinafter, for the sake of convenient explanation) having respective information processing functions, which are arranged in the home, have been connected to each other via a communication network 13, for example, a wireless LAN (Local Area Network), a wired LAN, Bluetooth, and UWB (Ultra Wide Band), which are wired in the home. In the home network 1, data may be transmitted/received among the respective information processing apparatuses via the communication network 13. The home network 1 contains a home server 3, a plurality of information processing apparatuses (in FIG. 1, only 3 sets of information processing apparatuses are recited, for the sake of convenient explanation) 5, 7, 9, and a router 11.

On the other hand, a file server 17 may be defined as an external server with respect to the home network 1, and is connected via the Internet 15 to the home network 1.

In the home network 1, the information processing apparatuses 5, 7, 9 indicate various sorts of appliances, for example, AV apparatuses such as a PC (Personal Computer), an HDD (Hard Disk Drive) recorder, a DVD (Digital Versatile Disk) recorder; domestic electric appliances such as an air conditioner; various sorts of sensors; NAS (Network Attached Storage); lighting fittings; and appliances such as a refrigerator, a microwave oven, and an electric clock. These information processing apparatuses 5, 7, 9 correspond to apparatuses which are applied to an OSGi framework. In the first embodiment, it is so assumed that the information processing apparatus 9 among these information processing apparatuses 5, 7, 9 corresponds to such an apparatus which has been newly entered to the home network 1, whereas any of the information processing apparatuses 5 and 7 correspond to such apparatuses which have been entered to this home network 1 before the information processing apparatus 9 is newly entered to the home network 1.

At least, middleware such as UPnP and Jini has been implemented on the information processing apparatus 5. The information processing apparatus 5 contains a program (will be referred to as “processing program” hereinafter) 19 which defines predetermined processing operations executed by respective preset units of the information processing apparatus 5. Initiating/stopping operations of this processing program 19 are controlled based upon an instruction which is outputted from the home server 3 via the communication network 13 to the information processing apparatus 5. That is, this instruction is outputted from the home server 3 from client programs (will be referred to as “client” hereinafter) 31, 33, 35 installed in this home server 3 via the communication network 13 to the information processing apparatus 5. Since the processing program 19 is initiated, a service specific to the information processing apparatus 5 is provided as a network service via the communication network 13 from the information processing apparatus 5 via the communication network 13 to the client programs (31, 33, 35) of the home server 3.

Similar to the installation in the information processing apparatus 5, at least middleware such as VPnP and Jini has also been installed on the information processing apparatus 7. The information processing apparatus 7 contains a processing program 21 which corresponds to predetermined processing operations executed by respective units of the information processing apparatus 7 in a similar to that of the information processing apparatus 5. Initiating/stopping operations of this processing program 21 are also controlled based upon an instruction which is outputted from the home server 3 via the communication network 13 to the information processing apparatus 7. That is, this instruction is outputted from the home server 3 (from client programs 31, 33, 35) installed in this home server 3 via the communication network 13 to the information processing apparatus 7. Since the processing program 21 is initiated, a service specific to the information processing apparatus 7 is provided as a network service via the communication network 13 from the information processing apparatus 7 via the communication network 13 to the client programs (31, 33, 35) of the home server 3.

Similar to the processing program 19 installed in the information processing apparatus 5, and the processing program 21 installed in the information processing apparatus 7, the information processing apparatus 9 contains a processing program 23 which corresponds to predetermined processing operations executed by the respective units of the information processing apparatus 9. Initiating/stopping operations of this processing program 23 are also controlled based upon an instruction which is outputted from the home server 3 via the communication network 13 to the information processing apparatus 9. Since the processing program 23 is initiated, a service specific to the information processing apparatus 9 is provided as a network service via the communication network 13 from the information processing apparatus 9 via the communication network 13 to the client programs (31, 33, 35) of the home server 3. The information processing apparatus 9 further contains an apparatus structural table 25 in addition to the above-described processing program 23. The apparatus structural table 25 is stored in, for example, an IC memory built in the information processing apparatus 9, or a storage device such as HDD built therein.

The apparatus structural service 25 has a function as a so-called “design drawing of service” which may be provided by the home network 1 with respect to a user. In the apparatus structural table 25, a list of services has been expressed which may be provided by the home network 1 with respect to the user and contains the information processing apparatus 9 as structural elements. As a consequence, the contents of the information stored in the apparatus structural table 25 are identified with the respective functions held by the information processing apparatuses (5, 7, 9) which constitute the home network 1, so that the services capable of being provided from the home network 1 to the user can be verified.

In other words, the below-mentioned information (data) has been stored in the apparatus structural table 25. That is, in such functions held by the respective information processing apparatuses (5, 7, 9) in order to separately provide the specific services (basic services), the above-described information indicates that if any of these functions are linked with each other, then such a service (will be referred to as “upper grade service” hereinafter) can be provided which is higher than any other services separately provided from the respective information processing apparatuses (5, 7, 9). It should also be noted that when each of the information processing apparatuses (5, 7, 9) provides each of the basic services to the user, for instance, UPnP, Jini, or the like is employed. A detailed content of the apparatus structural table 25 will be described later.

The information processing apparatus 9 retrieves the information processing apparatus (5, 7 etc.) on the home network 1 by utilizing, as previously explained, UPnP, Jini, or the like at such a timing when the own information processing apparatus 9 is newly entered to the home network 1, or at timing when another information processing apparatus (not shown) is newly entered to the home network 1. Since the information processing apparatus 9 performs the above-described retrieving operation, the information processing apparatus 9 selects such an information processing apparatus which is required to realize the upper grade service described in the apparatus structural table 25, and then, newly forms an apparatus management table 27.

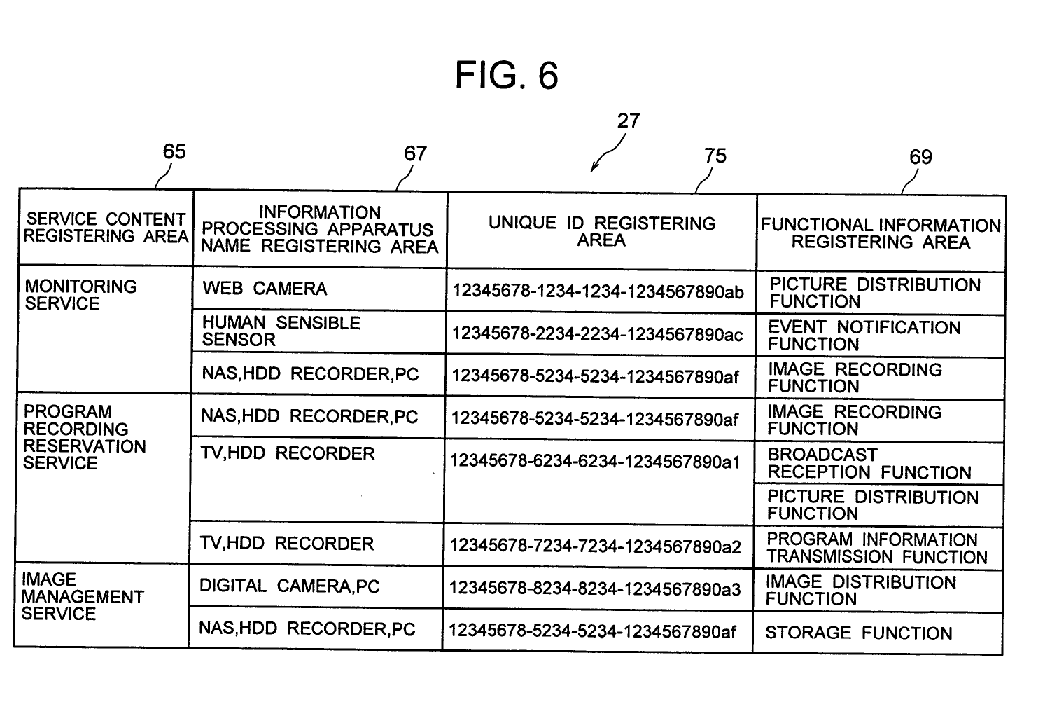

In this case, the apparatus management table 27 implies such a table which is constructed based upon the apparatus structural table 25. The apparatus management table 27 is constructed by that when an information processing apparatus (for example, information processing apparatus described in FIG. 6) described in the apparatus structural table 25 is present on the home network 1, a unique ID (unique ID) for identifying the information processing apparatus is acquired from this information processing apparatus, and then, the acquired unique ID is registered in a predetermined area (recited in FIG. 6) of the apparatus management table 27.

The information processing apparatus 9 stores the formed apparatus management table 27 in either the IC memory or the storage device such as HDD, which are built in the own information processing apparatus 9. Otherwise, the information processing apparatus 9 transfers the formed apparatus management table 27 via the communication network 13 to either other information processing apparatuses (5, 7) or the home server 3 so as to store the formed apparatus management table 27 in the IC memories, or the storage devices such as HDDs, which are built in these information processing apparatuses.

As shown in FIG. 1, in the first embodiment, the apparatus management table 27 is stored in the home server 3 (namely, IC memory, or storage device such as HDD built in this home server 3). To this end, the information processing apparatus 9 has stored an URL (Uniform Resource Identifier) in the storage device (either IC memory or IDD) built in the own information processing apparatus 9, while the URL indicates that a storage destination of the apparatus management table 27 is the home server 3 (storage device thereof). In this first embodiment, the information processing apparatus 9 installs the apparatus structural table 25 in the home server 3 via the communication network 13.

The information processing apparatus 9 utilizes UPnP, Jini, or the like, which is implemented on the home server 3 via the communication network 13 so as to initiate the processing program 23, since the processing program 23 executes a request notified via the communication network 13 from the client program (31, 33, 35) which is similarly implemented on the home server 3. As a result, a processed result obtained from the processing program 23 is returned (notified) via the communication network 13 to the client program (31, 33, 35) side of the home server 3, so that various sorts of services with respect to the client program (31, 33, 35) can be provided from the information processing apparatus 9.

In such a case that while the information processing apparatus 9 has storage areas for the application program 29, and the client programs 31, 33, 35, which should be implemented on the home server 3 within the storage device thereof, the application programs 29 and the client programs 31, 33, 35 have been stored in these storage areas, when these application programs 29, 31, 33, 35 are installed in the home server 3 of the apparatus structural table 25, the information processing apparatus 9 installs these application programs 29, 31, 33, 35 via the communication network 13. On the other hand, in the case that the information processing apparatus 9 does not have the above-described storage areas within the storage device, when these application programs 29, 31, 33, 35 are installed in the home server 3 of the apparatus structural table 25, the information processing apparatus 9 accesses the file server 17 through the communication network 13, the router 11, and the Internet 15. Then, the information processing apparatus 9 installs the application program 29, and the client programs 31, 33, 35, which have been stored in the file server 17, from the file server 17 via the communication network 13 to the home server 3.

In the first embodiment, the below-mentioned assumption is made: That is, in such a case that the information processing apparatus 9 manages other information processing apparatuses, namely the apparatus structural table 25 and the apparatus management table 27 of the home server 3 via the communication network 13, the information processing apparatus 9 not only provides services with respect to the client programs 31, 33, 35, which are installed in the home server 3, but also has a function as a client program in order to control services which should be provided by other information processing apparatuses, namely the information processing apparatuses 5 and 7.

At least, UPnP, Jini, or the like has been implemented in the home server 3. The home server 3 has been capable of using specific services as network services via the communication network 13, while these specific services are separately provided by the information processing apparatuses 5, 7, 9 (by separately executing processing programs 19, 21, 23). The home server 3 receives the apparatus structural table 25 which is transmitted from another information processing apparatus (namely, information processing apparatus 5 in first embodiment) for constituting the home network 1 via the communication network 13, and then, stores the received apparatus structural table 25 in a predetermined storage area of the storage device which is built in this apparatus structural table 25. Since the home server 3 receives the apparatus structural table 25 from the information processing apparatus 9, the home server 3 can provide such a service defined in the apparatus structural table 25 as the network service to the user.

In the first embodiment, as shown in FIG. 1, the apparatus structural table 25 has been managed by both the information processing apparatus 9 and the home server 3. Alternatively, the apparatus structural table 25 may be managed by the home server 3 in a batch manner.

Also, if the apparatus management table 27 formed based upon the apparatus structural table 25 by another information processing apparatus is transmitted form this information processing apparatus via the communication network 13, then the home server 3 receives the apparatus management table 27 and stores the received apparatus management table 27 in a predetermined storage area of the built-in storage device. As a result, the home server 3 can realize an upper grade service in which various services have been linked with each other, while these services are provided from the information processing apparatus 5 by initiating the processing program 19 of the information processing apparatus 5; from the information processing apparatus 7 by initiating the processing program 21 of the information processing apparatus 7, and from the information processing apparatus 9 by initiating the processing program 23 of the information processing apparatus 9, respectively.

In such a case that the above-described application program 29, and the client programs 31, 33, have not yet been installed, since the home server 3 implements, for instance, a framework such as OSGi, the home server 3 accesses the file server 17 via the communication network 13, the router 11, and the Internet 15 by utilizing the above-described OSGi. Then, the home server 3 downloads the above-described application program 29 and client programs 31, 33, 35, which have been stored in the file server 17 via the Internet 15, the router 11, and the communication network 13. As previously explained, in such a case that the above-described application program 29, and client programs 31, 33, 35 have been stored in the information processing apparatus 9, when the apparatus structural table 25 is installed from the information processing apparatus 9 via the communication network 13 to the home server 3, the home server 3 may alternatively install the application program 29, and the client programs 31, 33, 35.

When the apparatus structural table 25 is installed via the communication network 13 from the information processing apparatus 9 in the home server 3, the home server 3 retrieves such an information processing apparatus capable of providing the above-described upper grade service (namely, service desired by user) from the information processing apparatuses (5, 7) which constitute the home network 1 based upon the installed apparatus structural table 25. Then, the home server 3 forms the above-described apparatus management table 27 based upon the retrieved result, and stores this formed apparatus management table 27 in either the storage device (IC memory, or HDD) built in the home server 3 or the storage device (IC memory, or HDD) built in the information processing apparatus 9 via the communication network 13.

As previously described, when the apparatus management table 27 is stored in the storage device contained in the home server 3, a URL indicative of a storage destination of the apparatus management table 27 is stored in the storage device contained in the information processing apparatus 9.

The application program 29 is such a software for providing a desirable service within the user by controlling either one or the plurality of client programs (31, 33, 35) which are installed in the home server 3 in combination with this application program 29. The application program 29 is managed by management software which has been installed in the home server 3 so as to control a processing operation for the above-described upper grade service. Since the application program 29 is registered in this management software, the services can be provided with the user via the plurality of client programs (31, 33, 35) by executing the application program 29.

The management software can be added, corrected, and deleted with respect to the application program 29 in a similar manner to the plug-in. There are plural pieces of the application programs 29 to be registered in the management software, a total number of which is equal to that of the above-described upper grade services which are registered in the apparatus management table 27. As a consequence, when an upper grade service is additionally registered in the apparatus management table 27, such an application program 29 corresponding to the above-described upper grade service which is additionally registered is additionally registered in the management software, so that the total number of the application programs 29 to be registered in the management software may correspond with the total quantity of the upper grade services which are registered in the apparatus management table 27.

The application program 29 to be added to the management software is downloaded from the storage device built in the information processing apparatus 9 via the communication network 13 to the home server 3, or downloaded from the storage device built in the file server 17 via the Internet 15, the router 11, and the communication network 13 to the home server 3. It should be understood that when the client programs (31, 33, 35) which should be controlled by the application program 29 have not been installed in the home server 3, notification is issued from the application program 29 to the management software, so that a client program may be added, the existing client program may be corrected, and/or the existing client program may be deleted in a specific case.

The client programs 31, 33, 35 are such software which is implemented on the home server 3 by UPnP, Jini, or the like (of middleware), and correspond to software which requests provisions of network services which are realized by initiating these processing programs 19, 21, 23, while these processing programs 19, 21, 23 are implemented on the information processing apparatuses 5, 7, 9 by UPnP, Jini, or the like. A relationship between the client programs 31, 33, 35, and the processing programs 19, 31, 23 is established by that any of these client programs 31, 33, 35 may request to separately provide network services with respect to the processing programs 19, 21, 23, respectively. However, in the first embodiment, for the sake of convenient explanations, it is so assumed that the client program 31 can request to provide the network service only with respect to the processing program 19; the client program 33 can request to provide the network service only with respect to the processing program 21; and the client program 35 can request to provide the network service only with respect to the processing program 23.

The router 11 connects the file server 17 with the home network 1 corresponding to an in-home communication network via the Internet 15 corresponding to an out-home communication network. As a result, various sorts of data can be transmitted/received between the respective units (information processing apparatuses 5, 7, 9) which constitute the home network 1, for instance, the home server 3 as the beginning, and the file server 17.

The Internet 15 is such a communication network which is capable of transmitting/receiving data in accordance with a predetermined sequence between a certain apparatus and another apparatus (between respective units (home server 3, information processing apparatuses 5, 7, 9) which constitute home network 1, and file server 17 as explained in first embodiment). The Internet 15 is arranged by an optical line network, a CATV (Cable Television) network, a telephone line network, or the like.

The file server 17 corresponds to an apparatus which is applied to the OSGi framework, and stores thereinto application programs, and the like, which are required by, for example, the respective information processing apparatuses 5, 7, 9, which constitute the home network 1. When such a request for downloading an application program is issued from the above-described information processing apparatus (namely, any one of apparatuses 5, 7, 9) via the Internet 15 (on side of home network 1), the file server 17 retrieves the application program corresponding to this request from the application programs which have been stored. Then, the file server 17 transmits the retrieved application program via the Internet 15 (on the side of home network 1) to the above-explained information processing apparatus (any one of apparatuses 5, 7, 9). As a result, the functions held by the information processing apparatuses (5, 7, 9) contained in the home network 1 can be added, and the functions can be changed.

As previously explained in FIG. 1, in the information processing system according to one embodiment of the present invention, this system has been arranged by that the home server 3 is present on the home network 1. However, in the case that the home server 3 is not present on the home network 1, the above-described information processing system may be alternatively realized by giving the function of the home server 3 to any one of the information processing apparatuses present on the home network 1. In this alternative case, it is not a true that the plurality of application programs (29) must be managed only by one set of such an information processing apparatus having the function of the home server 3. However, if there are plural sets of information processing apparatuses capable of managing the application programs 29, the apparatus structural tables 25, and the apparatus management tables 27, then each of the plural information processing apparatuses may alternatively manage one, or more pieces of the application programs 29.

Also, although the first embodiment has described that the middleware used to provide the network service to the user is implemented by UPnP, the above-described middleware is not necessarily limited only to UPnP. In an actual case, if there are such protocols having the below-mentioned functions, then any of these protocols may be alternatively utilized. That is, these protocols may have the functions which may automatically detect an information processing apparatus added to the home network 1, and may notify such a service which may be provided by the detected information processing apparatus to an information processing apparatus on the home network 1.

As previously described, in the first embodiment, the plural sets of information processing apparatuses (5, 7, 9) and the home server 3 are present on the home network 1, while the processing programs (19, 21, 23) required for providing the different services with respect to the user are implemented on these information processing apparatuses (5, 7, 9) respectively. Then, the client programs (31, 31, 35) and the application program 29 for managing the respective client programs (31, 33, 35) in the unification manner have been implemented on the home server 3, while the client programs (31, 33, 35) issue the requests with respect to the processing programs (19, 21, 23). Since the home network 1 is arranged in the above-described manner, the user can receive the desirable service from the home network 1 under such a condition that the user can also and easily operate the home server 3, while the user need not pay his specific attention to the respective services.

For instance, in the case that the user wants to view a recorded TV program by employing a portable terminal, the below-mentioned respective processing operations are required: That is, the user obtains recording reservation of the TV program, and furthermore, if the recording operation is ended, then the recorded TV program is trans-coded to a format of contents which can be reproduced by the portable terminal, and the coded contents are transferred to an HDD, or the like mounted on the portable terminal.

The above-described respective process operations may be realized by utilizing services and the like, which are provided via an HDD recorder, a PC, the Internet, and so on. However, very cumbersome operations are necessarily required until the user can view the TV program on the portable terminal by sequentially executing various steps of these processing operations. Under such a circumstance, as described in this first embodiment, an upper grade service for managing the individual services in the unification manner is defined, and also, the application program 29 for executing the upper grade service is implemented on the home server 3. As a result, the operations of the home server 3 by the user can be simplified.

Also, in the first embodiment, while the apparatus structural table 25 has been previously stored in the storage device of the information processing apparatus 9, when this information processing apparatus 9 is newly entered to the home network 1, the apparatus structural table 25 is transmitted via the communication network 13 to the home server 3. The home server 3 retrieves the information processing apparatuses (5, 7, 9) on the home network 1 in order to evaluate whether or not various sorts of services described in the apparatus structural table 25 can be provided, and then forms the apparatus management table 27. Then, if necessary, both the client programs (31, 33, 35) for utilizing the services provided by the information processing apparatuses (5, 7, 9), and the application program 29 for managing these client programs (31, 33, 35) in the unification manner are downloaded from either the file server 17 (located outside home) or the information processing apparatus 9 so as to be installed. As a result, the upper grade service realized by linking the previously explained services with each other, which are specific to the respective information processing apparatuses (5, 7, 9) can be provided to the user.

Furthermore, in accordance with one embodiment of the present invention, when the information processing apparatus 9 is newly entered to the home network 1, the upper grade service realizable under the present environment of the home network 1 can be immediately notified with respect to the user, and can be utilized.

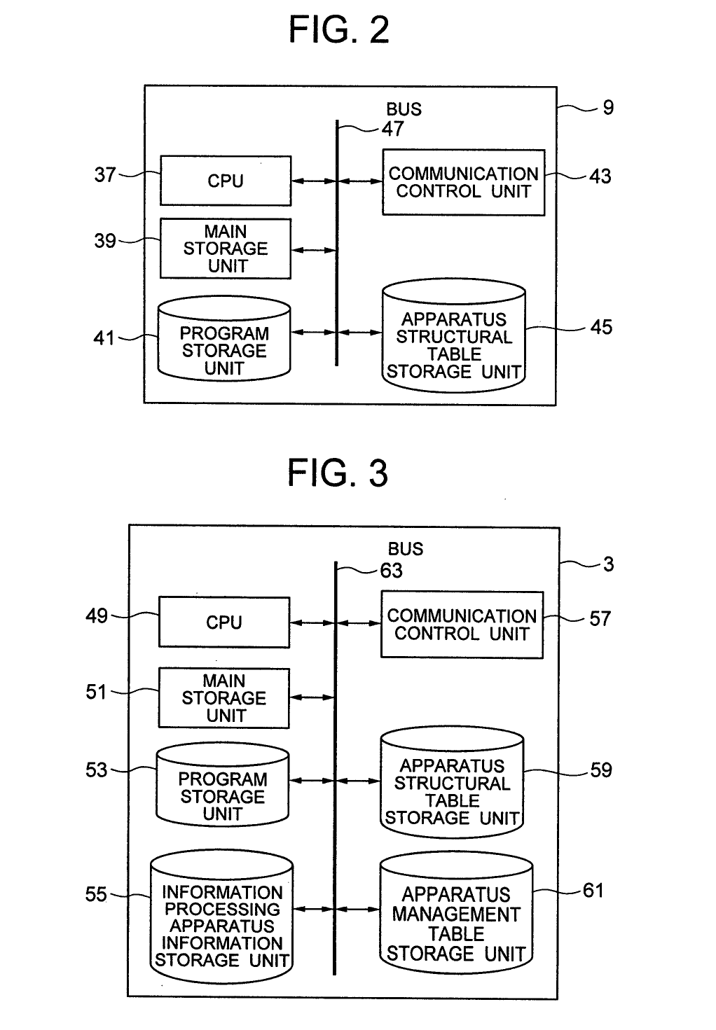

FIG. 2 is a functional block diagram for showing one example as to an internal arrangement of the information processing apparatus 9 provided in the information processing system according to the first embodiment of the present invention. The information processing apparatus 9 shown in FIG. 2 corresponds to such an information processing apparatus which is newly entered to the home network 1 in FIG. 1.

A hardware structure of the information processing apparatus 9 is substantially identical to a hardware structure of the information processing apparatus 5, or 7 shown in FIG. 1. As indicated in FIG. 2, the information processing apparatus 9 has been arranged by containing a CPU 37, a main storage unit 39, a program storage unit 41, a communication control unit 43, and an apparatus structural table storage unit 45 in such a manner that these units have been connected to each other via a bus 47.

The main storage unit 39 is constructed of, for example, a RAM (Random Access Memory) unit, and a ROM (Read-Only Memory) unit. Under control of the CPU 37, the RAM unit functions as a work area, and the ROM unit functions as an area for storing thereinto a program which is required by the information processing apparatus 9 (CPU 37).

The program storage unit 41 is a device which stores thereinto a program for controlling a processing operation of the information processing apparatus 9 (CPU 37) under control of the CPU 37. As the program storage unit 41, for example, an HDD (Hard Disk Drive), an optical disk, a Flash memory, and the like are employed.

The apparatus structural table storage unit 45 is a device which saves the above-described apparatus structural table 25 under control of the CPU 37. Similar to the program storage unit 41, as the apparatus structural table storage unit 45, for instance, an HDD, an optical disk, a Flash memory and the like are employed.

The communication control unit 43 is such a device which transmits/receives data between the home server 3 and other information processing apparatuses (5, 7) on the home network 1 via the communication network 13 under control of the CPU 37. As the communication control unit 43, for example, a modem, a network adaptor, and the like are employed. It should also be noted that in such a case where the data transmission/reception between the information processing apparatus 9 and another information processing apparatus (5, 7) on the home network 1, or the home server 3 are carried out by a wireless communication, a wireless transmitting/receiving apparatus is employed in the communication control unit 43.

The CPU 37 controls the respective units of the information processing apparatus 9 in order to realize the function held by the information processing apparatus 9 based upon a program which has been previously stored in the main storage unit 39, and a program which has been previously stored in the program storage unit 41.

In the case that the application program 29 is managed by the information processing apparatus 9, in addition to the above-described respective units, such a device as an apparatus management table storage unit (not shown) and an information processing apparatus information storage (not shown) is furthermore required, and also, the application program 29 to be managed is stored in the program storage unit 41.

FIG. 3 is a functional block diagram for showing one example as to an internal arrangement of the home server 3 provided in the information processing system according to the first embodiment of the present invention.

As represented in FIG. 3, the home server 3 has been arranged by containing a CPU 49, a main storage unit 51, a program storage unit 53, an information processing apparatus information storage unit 55, a communication control unit 57, an apparatus structural table storage unit 59, and an apparatus management table storage unit 61 in such a manner that these units have been connected to each other via a bus 63.

The main storage unit 51 is constructed of, for example, a RAM unit, and a ROM unit. Under control of the CPU 49, the RAM unit functions as a work area, and the ROM unit functions as an area for storing a program which is required by the home server 3 (CPU 49).

The program storage unit 53 is a device which stores thereinto a program for controlling a processing operation of the home server (CPU 49) under control of the CPU 49. As the program storage unit 53, for example, an HDD, an optical disk, a Flash memory, and the like are employed.

The information processing apparatus information storage unit 55 is such a device for saving an information processing apparatus information table which contains names of information processing apparatuses for constructing the home network 1, and unique IDs applied to the relevant information processing apparatuses under control of the CPU 49. Similar to the structure in the program storage unit 53, as the information processing apparatus information storage unit 55, for instance, an HDD, an optical disk, a Flash memory, and the like are employed.

The apparatus structural table storage unit 59 is such a device which saves the above-described apparatus structural table 25 under control of the CPU 49. Similar to those of the information processing apparatus information storage unit 55, and the program storage unit 53, as the apparatus structural table storage unit 59, for instance, an HDD, an optical disk, a Flash memory, and the like are employed. In such a case that plural sets of the information processing apparatuses 9 are present which correspond to information processing apparatuses newly entered to the home network 1, apparatus structural tables which are installed by the respective information processing apparatuses 9 via the communication network 13 to the apparatus structural table storage unit 59 are managed by the CPU 49 in a separation manner as to the corresponding information processing apparatuses 9.

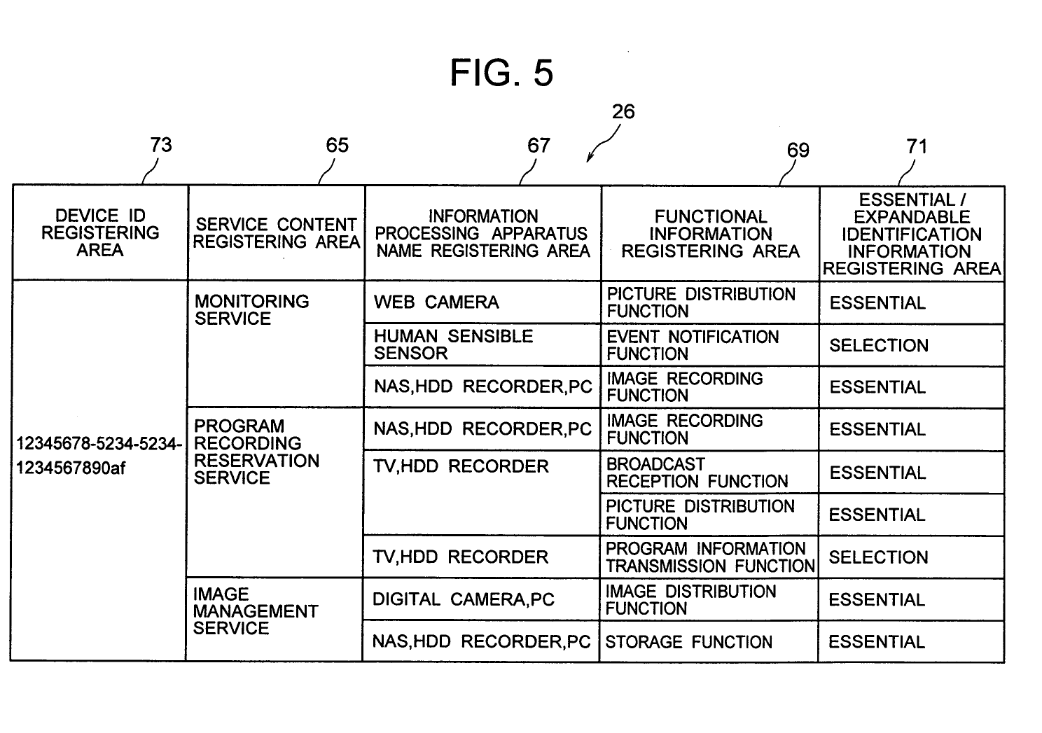

The separating management for the apparatus structural table 25 by the CPU 49 based upon the information processing apparatuses 9 is carried out as follows: That is, for example, while the unique IDs of the respective information processing apparatuses 9 are utilized, the apparatus structural tables 25 are registered in the apparatus structural table storage unit 59, depending upon the sort of information processing apparatus. It should also be noted that FIG. 5 indicates such an apparatus structural table 25 after being stored in the apparatus structural table storage unit 5.

The apparatus management table storage unit 61 is a device which saves the above-explained apparatus management table 27 under control of the CPU 49. Similar to the structures in the program storage unit 53, the information processing apparatus information storage unit 55, and the apparatus structural table storage unit 59, as the apparatus structural table storage unit 61, for instance, an HDD, an optical disk, a Flash memory, and the like are employed.

The communication control unit 57 is such a device which transmits/receives data between the home server 3 and other information processing apparatuses (5, 7, 9) on the home network 1 via the communication network 13 under control of the CPU 49. As the communication control unit 57, for example, a modem a network adaptor, and the like are employed. It should also be noted that in such a case where the data transmission/reception between other information processing apparatuses (5, 7, 9) on the home network 1 and the home server 3 are carried out by a wireless communication, a wireless transmitting/receiving apparatus is employed in the communication control unit 57.

The CPU 49 controls the respective units of the home server 3 in order to realize the functions held by the home server 3 based upon a program which has been previously stored in the main storage unit 51, and a program which has been previously stored in the program storage unit 53.

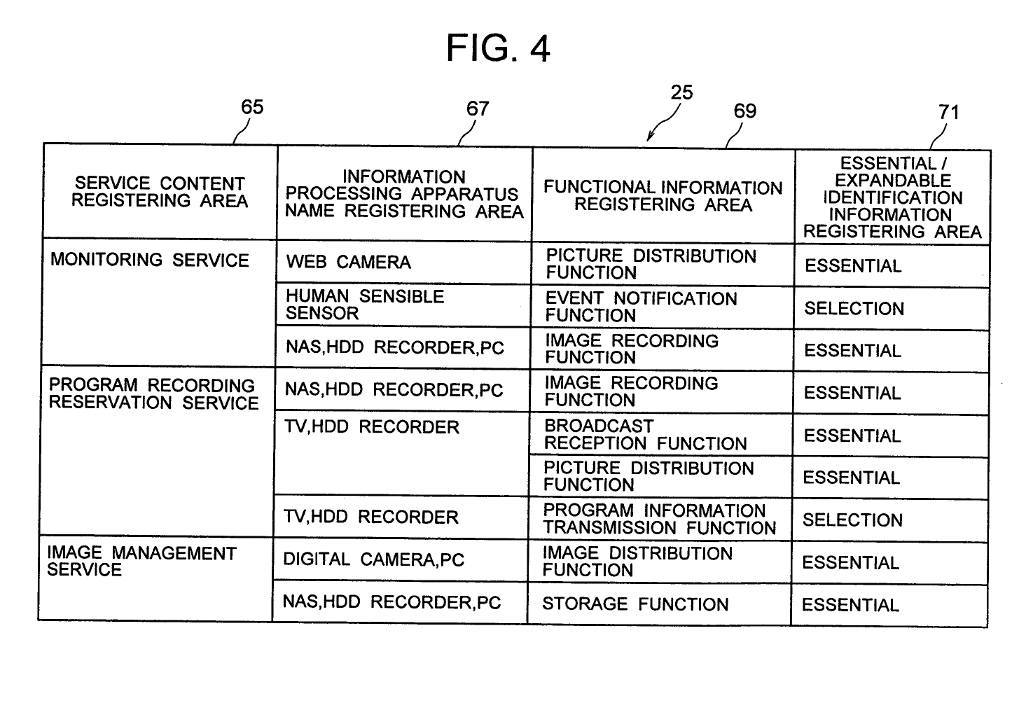

FIG. 4 is an explanatory diagram for representing one example of the apparatus structural table 25 according to the first embodiment of the present invention.

As shown in FIG. 4, the apparatus structural table 25 contains a service content registering area 65, an information processing apparatus name registering area 67, a functional information registering area 69, and an essential/extendable identification information registering area 71.

Services which may be defined as upper grade services among the services to be provided to the user in the home network 1 shown in FIG. 1 are registered in the service content registering area 65 in such a manner that these services may be managed in a unification manner. It should be understood that as previously described, these services are provided to the user in response to requests for providing the services with respect to the processing programs (19, 21, 23) which are installed from the plurality of client programs (31, 33, 35) installed in the home server 3 to the plural sets of information processing apparatuses (5, 7, 9).

In the information processing apparatus name registering area 67, such an information is registered, while the information is required to identify whether or not an information processing apparatus (5, 7, 9) present on the home network 1 shown in FIG. 1 is equal to such an information processing apparatus which is required for providing a service to be registered in the service content registering area 65 with the user. It is so assumed that the information processing apparatus 9 which saves the apparatus structural table 25 is necessarily registered in the information processing apparatus name registering area 67. As to modes of information to be registered in the information processing apparatus name registering area 67, if modes can identify sorts of the information processing apparatuses, then any of these modes may be utilized.

In the functional information registering area 69, such an information is registered, while this information is related to a function which is implemented by an information processing apparatus (5, 7, 9) present on the home network 1 shown in FIG. 1, namely such an information processing apparatus which is required for providing a service to be registered in the service content registering area 65 with the user.

In the essential/extendable identification information registering area 71, identification information, namely a flag has been registered. The identification information (namely, flag) indicates whether each of functions to be registered in the functional information registering area 69 corresponds to an essential function for providing a service previously registered in the service content registering area 65, or corresponds to an essential function for further extending the registered service.

In the example shown in FIG. 4, a monitoring service corresponding to an upper grade service, which has been stored in the service content registering area 65 can be realized by a Web camera, a human sensible sensor, an NAS, an HDD recorder, a PC etc., which correspond to apparatus names stored in the information processing apparatus name registering area 67. As apparent with reference to the functional information registering area 69, the Web camera is equipped with a picture distribution function; the human sensible sensor is equipped with an even notification function; and the NAS, the HDD recorder, the PC, and the like are equipped with an image recording function. As apparent with reference to both the functional information registering area 69 and the essential/extendable identification information registering area 71, both the picture distribution function and the image recording function correspond to such functions (will be referred to as “essential functions” hereinafter) which are essentially required so as to realize the monitoring service. The event notification function corresponds to such a function (will be referred to as “extendable function” hereinafter) which further extend the monitoring function.

Next, a program recording reservation service corresponding to another upper grade service can be realized by an NAS, an HDD recorder, a PC, a TV, and the like. The NAS, the HDD recorder, and the PC are equipped with the image recording function; and the TV and the HDD recorder are equipped with a broadcast reception function, a picture distribution function, and a program information transmission function. The image recording function, the broadcast reception function, and the picture distribution function correspond to the essential functions for the program decoding reservation service. The program information transmission function corresponds to an extendable function.

Furthermore, an image management service corresponding to a further upper grade service can be realized by a digital still camera, a PC, an NAS, an HDD recorder, and the like. The digital still camera and the PC are equipped with an image distribution function; and the NAS, the HDD recorder, and the PC are equipped with a storage function. Any of the image distribution function and the storage function are the essential functions with respect to the image management service.

FIG. 5 is an explanatory diagram for showing one example as to a structure when the apparatus structural table 25 recited in FIG. 4 has been stored in the information processing apparatus 9, or the home server 3.

In such a case that the apparatus structural table 25 recited in FIG. 4 has been stored in either the information processing apparatus 9 or the home server 3, the apparatus structural table 25 is arranged by that a device ID registering area 73 has been further added in addition to the service content registering area 65, the information processing apparatus name registering area 67, the functional information registering area 69, and the essential/expandable identification information registering area 71. This is the apparatus structural table 26 shown in FIG. 5. In this device ID registering area 73, an ID (namely, device ID) as identification information is registered, while the identification information is related to such an apparatus (information processing apparatus 9 in first embodiment) corresponding to an installation source of the apparatus structural table 25. In other words, the apparatus structural table 26 indicated in FIG. 5 is formed by such a manner that the device ID for identifying the information processing apparatus 9 corresponding to the installation source is registered in the device ID registering area 73 with respect to the apparatus structural table 25 installed from the information processing apparatus 9 to the home server 3. As a result, the information processing apparatus 9 corresponding to the installation source is defined in correspondence with the apparatus structural table 25 transmitted from the information processing apparatus 9 to the home server 3.

In the first embodiment, as apparent with reference to the device ID registering area 73 of FIG. 5, as the device ID, “12345678-5234-5234-1234567890af” has been applied to the information processing apparatus 9.

The apparatus structural table 26 indicated in FIG. 5 is consulted after the apparatus structural table 25 is installed from the information processing apparatus 9 to the home server 3 so that the apparatus management table 27 is formed in the home server 3, and furthermore, when a novel information processing apparatus different from the above-described information processing apparatus 9 is newly entered to the home network 1, or when such an information processing apparatus implemented with UPnP, or the like and capable of providing a service is newly entered to the home network 1. In other words, in the home server 3, when a judgement is made that the novel information processing apparatus, or the like is newly entered to the home network 1 by referring to the apparatus structural table 26 and by retrieving the device ID registering area 73, such an information processing apparatus which corresponds to an (upper grade) service registered in the service content registering area 65 is retrieved from the information processing apparatus name registering area 67. Since this retrieving operation is performed, a check is made as to whether or not there is a service (network service) which can be newly provided to the user.

As a result of this checking operation, when the service which can be provided to the user is found out, the found service is registered in the apparatus management table 27 by the home server 3, and such a notification that the registered service can be utilized is issued to the user. In the processing operation for installing the apparatus structural table 25 from the information processing apparatus 9 to the home server 3, it is desirable to implement UPnP, or the like. In this case it is required to describe a URL for downloading the application program 29 and the client program (31, 33, 35) in, for example, Presentation URL, or the like.

FIG. 6 is an explanatory diagram for showing one example of the apparatus management table 27 according to the first embodiment of the present invention.

As shown in FIG. 6, the apparatus management table 27 contains a service content registering area 65, an information processing apparatus name registering area 67, and a functional information registering area 69 in addition to a unique ID registering area 75 which is equal to a storage area corresponding to the device ID registering area 73 recited in FIG. 5, while this apparatus management table 27 is similar to the apparatus structural tables (25, 26) described in FIG. 4 and FIG. 5. Device IDs, namely unique IDs are stored in the unique ID registering area 75, while these device IDs are the same information as the information to be stored in the device ID registering area 73.

When the apparatus structural table 25 is installed from the information processing apparatus 9 to the home server 3, the information processing apparatuses (5, 7, 9) employed in the home network 1 and the functions which are separately provided by these information processing apparatuses (5, 7, 9) are retrieved from the installed apparatus structural table 25 in the home server 3. Then, the information processing apparatuses (5, 7, 9) which are obtained from the above-described retrieved result and are required so as to realize the upper grade service are identified with the functions held by these information processing apparatuses (5, 7, 9), and services which can be provided to the user are extracted from the respective upper grade services (list) registered in the service content registering apparatus 65, and then, the apparatus management table 27 is formed. The apparatus management table 27 is registered in the apparatus management table storage unit 61 shown in FIG. 3 in the home server 3.

In this case, as to the unique IDs stored in the unique ID registering area 75, the information processing apparatuses (5, 7, 9) on the home network 1 must be identified based upon these unique IDs. For instance, in the case that UPnP, or the like has been implemented in home server 3, it is desirable to employ a method for utilizing a UDN (Unique Device Name).

In the case that there are plural sets of information processing apparatuses (5, 7, 9) having the same function on the home network 1, as to the unique IDs of the apparatus management table 27, a plurality of unique IDs may be registered with respect to each of these information processing apparatuses (5, 7, 9) having the same function in order that the client program (31, 33, 35) on the home-server 3 may utilize any of these information processing apparatuses (5, 7, 9). While plural sets of the information processing apparatuses (5, 7, 9) having the same function are present within a home, in such a case that these information processing apparatuses are such information processing apparatuses capable of establishing a link relationship, for instance, a TV and a speaker, a temperature and an air conditioner, a positional relationship among these information processing apparatuses (5, 7, 9) may become important. However, since the positional information among the respective information processing apparatuses (5, 7, 9) within the home can be hardly grasped, when it can be judged that there are plural sets of the information processing apparatuses (5, 7, 9) having the same function, the user is required to set positional information as to the respective information processing apparatuses (5, 7, 9). Also, it is required to determine a management method capable of grasping that such a positional information set by the user is related to any one of these information processing apparatuses (5, 7, 9).

Alternatively, while the unique IDs registered in the unique ID registering area 75 of the apparatus management table 27 are not used, the information processing apparatuses (5, 7, 9) on the home network 1 may be retrieved every time a service requested from the client program (31, 33, 35) side is executed. In the case that the positional relationship among the information processing apparatuses (5, 7, 9) becomes important, for the sake of easy utilization by the user, it is desirable that only the unique IDs of the information processing apparatuses (5, 7, 9) set by the user are managed.

In the first embodiment, as apparent with reference to FIG. 6 (namely, both information processing apparatus name registering area 67 and unique ID registering area 75), such a unique ID of “12345568-1234-1234-1234567890ab” has been applied to the Web camera; such a unique ID of “12345678-2234-2234-1234567890ac” has been applied to the human sensible sensor; such a unique ID of “12345678-5234-5234-1234567890af” has been applied to the NAS, the HDD recorder and the PC; and also such a unique ID of 12345678-6234-6234-1234567890a1” has been applied to the TV and the HDD recorder, respectively. Moreover, such a unique ID of “12345678-7234-7234-1234567890a2” has been applied to both the TV and the HDD recorder as such information processing apparatuses having a function different from the above-described function.

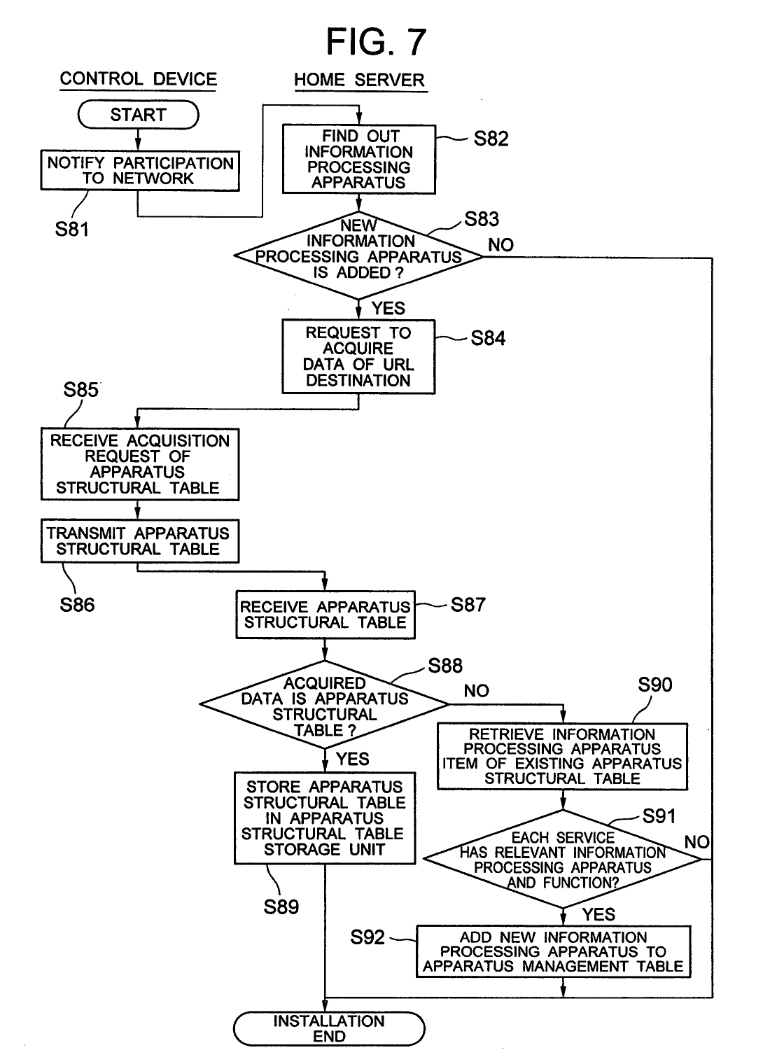

FIG. 7 is a flow chart for describing process sequences executed when the apparatus structural table 25 is installed from the information processing apparatus 9 to the home server 3 in the information processing system according to the first embodiment of the present invention.

In FIG. 7, firstly, such an information processing apparatus 9 which is tried to be newly entered to the home network 1 is connected via the communication network 13 to both other information processing apparatuses (5, 7) on the home network 1 and the home server 3, and also, notifies such a message that the own information processing apparatus 9 has been newly entered to both the home server 3 and other information processing apparatuses (5, 7) (step S81). When the home server 3 recognizes that the information processing apparatus 9 is newly entered to the home network 1 by receiving the above notification, the home server 3 acquires device information where a sort of the information processing apparatus 9, a list of functions held by the information processing apparatus 9, a unique ID of the information processing apparatus 9, a URL (Uniform Resource Locator) capable of acquiring the apparatus structural table 25, and the like have been described. Then, the home server 3 acquires the unique ID of the information processing apparatus 9 from the above-described device information (step S82).

Next, the home server 3 refers to the apparatus structural table 26 stored in the information processing apparatus information table storage unit 55 (shown in FIG. 3) so as to retrieve unique IDs, and checks whether or not such an information processing apparatus having the same unique ID is present (step S83). As a result of this checking operation, if the home server 3 confirms that the same unique ID is not present in the apparatus structural table 26 (YES in step S83), then the home server 3 transmits a request of acquiring the apparatus structural table 25 with respect to the information processing apparatus 9 by utilizing the URL contained in the device information (step S84).

When the above-described acquisition request is transmitted from the home server 3, the information processing apparatus 9 receives this acquisition request (step S85). The information processing apparatus 9 reads out the apparatus structural table 25 from the apparatus structural table storage unit 45 in response to the acquisition request, and then transmits the read apparatus structural table 25 to the home server 3 (step S86). If the apparatus structural table 25 is transmitted from the information processing apparatus 9, then the home server 3 receives this apparatus structural table 25 (step S87). Next, the home server 3 checks whether or not information (data) received from the information processing apparatus 9 is the apparatus structural table 25 (step S88).

As a result of this checking operation, when the home server 3 confirms that the information (data) sent from the information processing apparatus 9 is the apparatus structural table 25 (YES in step S88), the home server 3 defines the acquired apparatus structural table 25 in correspondence with the previously acquired unique ID related to the information processing apparatus 9. Then, the home server 3 stores the apparatus structural table 25 after being defined in correspondence with the unique ID in the apparatus structural table storage unit 59 (step S89). Then, a series of the processing operations is accomplished.

On the other hand, as a result of checking whether or not the information (data) received from the information processing apparatus 9 is the apparatus structural table 25, if the home server 3 confirms that the received information is not the apparatus structural table 25 (“NO” in step S88), then the home server 3 retrieves the information processing apparatus name registering area 67 contained in the existing apparatus structural table (25), while the sort information of the information processing apparatus 9 is employed as a retrieve key and this sort information corresponds to one of the device information related to the information processing apparatus 9 acquired in the step S82 (step S90). As a result of the above-described retrieving operation, in the case that the home server 3 could not find out the relevant information processing apparatus within the above-described information processing apparatus name registering area 67, or in such a case where although the relevant information processing apparatus could be found out, the home server 3 can reveal that the function required (by the user) is not present in the list of functions held by the information processing apparatus 9 and acquired in the step S82 (“NO” in step S90), the series of the above-described processing operations is immediately accomplished.

As a result of retrieving operation of the information processing apparatus name registering area 67 contained in the existing apparatus structural table (25), in the case that the home server 3 could find out the relevant information processing apparatus, and further, can reveal that the function required (by the user) is present in the list of functions held by the information processing apparatus 9 and acquired in the step S82 (“YES” in step S90), the home server 3 retrieves the apparatus management table 27 stored in the apparatus management table storage unit 61, while the upper grade service which contains the relevant information processing apparatus (has been stored in service content registering area 65) is employed as a retrieve key. Then, the home server 3 registers the unique ID acquired in the step S82 in the unique ID registering area 75 of the above-described information processing apparatus, which is required in order to execute the relevant upper grade service registered in the service content registering area 65 of the apparatus management table 27 (step S92), and then, the series of processing operations is completed.

It should be noted that the home server 3 checks whether or not the information processing apparatus having the same unique ID by referring to the apparatus structural table 26 stored in the information processing apparatus information table storage unit 55, and if the home server 3 confirms that the same unique ID is present (“NO” in step S83), then the home server 3 judges that the information processing apparatus 9 has already been registered, and thus, the series of processing operations is accomplished.

When the apparatus structural table 25 is transmitted to the home server 3 and is registered in the apparatus structural table 59 of the home server 3, both the client program 35 for controlling the information processing apparatus 9, and the application program 29 for controlling the plurality of information processing apparatuses (5, 7) are required to be installed in the home server 3. In such a case that HAVi (Home Audio/Video interoperability) has been installed in both the information processing apparatus 9 and the home server 3, and furthermore, the client program 35 and the application program 29 which are initiated in the home server 3 have been stored in the program storage unit 41 of the information processing apparatus 9, both the client program 35 and the application program 29 may be alternatively installed in an automatic manner from the information processing apparatus 9 to the home server 3 by utilizing the HAVi middleware after the process operations explained in FIG. 7 are accomplished. However, in the first embodiment, when the client program 35 and the application program 29 are installed in the home server 3, it is so designed that the installation method using the OSGi framework is employed. As a result, a description is made of a method for installing the client program 35 and the application program 29 in the home server 3 in the below-mentioned description, while the OSGi framework is utilized.

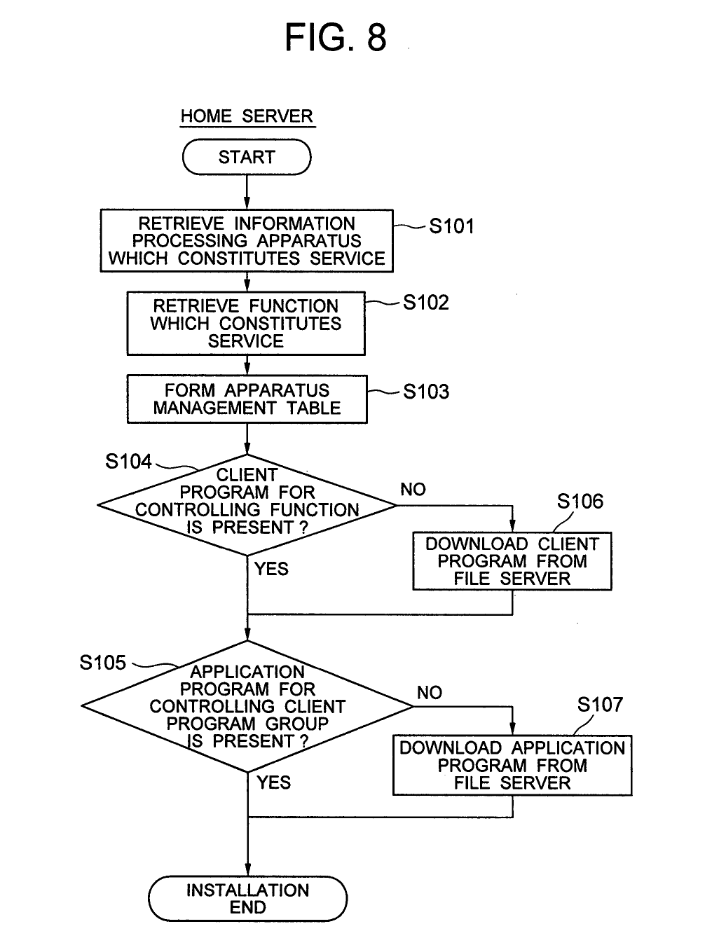

FIG. 8 is a flow chart for describing process sequences executed when the client program 35 and the application program 29 are installed in the home server 3, according to the first embodiment of the present invention.

In FIG. 8, the home server 3 firstly refers to the apparatus structural table 25 in order to retrieve all of the information processing apparatuses (5, 7, 9) on the network 1. When UPnP has been installed in the home server 3, since the information processing apparatus information can be acquired by performing the device description, the home server 3 retrieves that a sort of an information processing apparatus indicated in the acquired information corresponds to any one of the information processing apparatuses registered in the information processing apparatus name registering area 67 of the apparatus structural table 25. This retrieving operation is carried out with respect to all of the information processing apparatus information acquired by the above-described device description. As a result of the above-described retrieving operation, in such a case that the information processing apparatus information acquired by the home server 3 does not correspond to any one of the information processing apparatuses registered in the information processing apparatus name registering area 67, the process sequences shown in FIG. 8 are not carried out (step S101).

As a result of the above-described retrieving operation, in such a case that the information processing apparatus information acquired by the home server 3 corresponds to any one of the information processing apparatuses registered in the information processing apparatus name registering area 67, the home server 3 checks whether or not the function held by the information processing apparatus registered in the information processing apparatus name registering area 67 is held by the relevant information processing apparatus by identifying the function held by the relevant information processing apparatus with the functions (namely, list of functions held by relevant information processing apparatus) which have been registered in the functional information registering area 69 as the functions held by the above-explained information processing apparatus. As a result of this checking operation, if the function held by the relevant information processing apparatus is present in the function list, and if this function is not present in the function although the process sequences shown in FIG. 8 are performed, then the process sequences indicated in FIG. 8 are not carried out (step S102).

As a result obtained by performing the above-described process operations (indicated by step S101 and step S102 respectively) with respect to all of the information processing apparatuses (5, 7, 9) on the home network 1, in the case that the home server 3 can reveal that there is such an information processing apparatus capable of providing at least a function which is required to execute the upper grade service registered in the service content registering area 65, the home server 3 additionally registers the above-described upper grade service in the apparatus management table 27. Then, the home server 3 additionally registers UDN of the above-described information processing apparatus in the unique ID registering area 75 which is allocated to the information required in order to execute the additionally registered upper grade service (step S103).

At a time when the above-described process operation with respect to the apparatus management table 27 is accomplished, a check is made to the home server 3 whether or not the client programs (31, 33, 35) are present on the home server 3, while these client programs are provided so as to control the process operation of the information processing apparatus required for executing the added upper grade service. As a result of this checking operation, when the home server 3 confirms that the client programs (31, 33, 35) are not present (“NO” in step S104), the home server 3 accesses the file server 17 present on the Internet 15. Then, the home server 3 retrieves necessary software while various sorts of information are employed as a retrieve key, and thus, downloads the necessary software from the file server 17. There sorts of information contain the upper grade service which should be provided to the user, the information processing apparatuses (5, 7, 9) which should be controlled, the functions held by the respective information processing apparatuses (5, 7, 9), and the like.

In a manner for downloading the client programs (31, 33, 35), in the case that the OSGi framework has been installed in both the home server 3 and the file server 17, there is no problem even when the above-described downloading operation is carried out by utilizing the function of the OSGi framework (step S106). Moreover, in the case that the application program 29 is not present on the home server 3 (step S105), the home server 3 accesses the file server 17 while the above-explained upper grade service is employed as the retrieve key, and thus, downloads the relevant application program 29 from the file server 17 (step S107).

Either the downloading operation of the client programs (31, 33, 35) in the step S106 is ended or the downloading operation of the application program 29 in the step S107 is accomplished, and then, the installation works of these software to the home server 3 are accomplished, so that the series of process operations is completed. In the case that the software which should be downloaded from the file server 17 has already been present on the home server 3 in the step S104 and the step S105, the downloading process operations in the step S106 and the step S107 do not occur (“YES” in step S104 and step S105 respectively).

Next, a description is made of a method for executing the application program 29 on the home server 3.

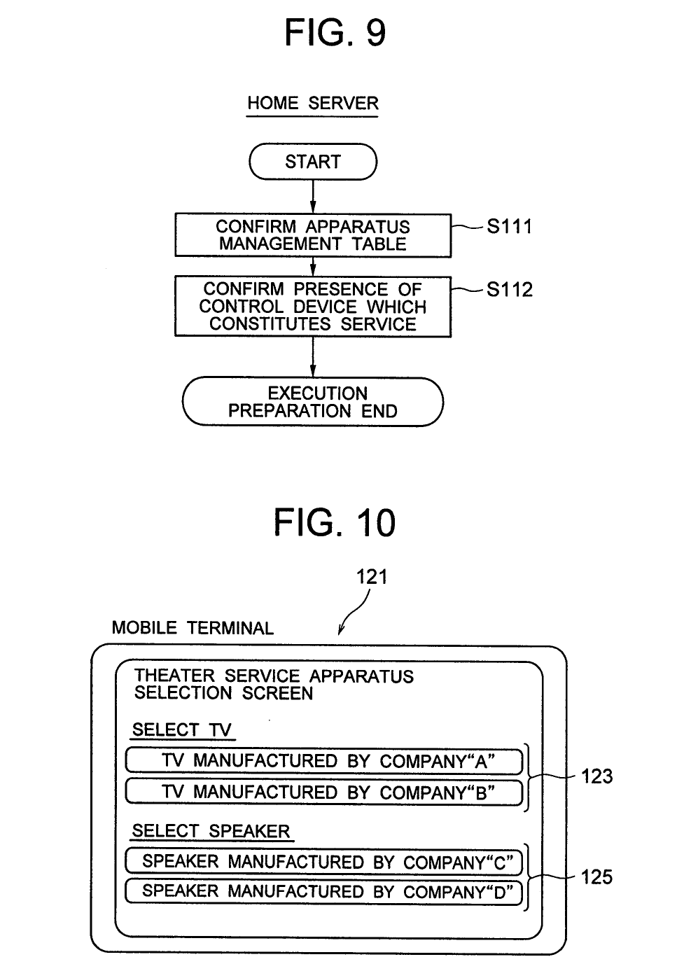

FIG. 9 is a flow chart for indicating one example as to process operations of the application program 29 which is initiated on the home server 3, according to the first embodiment of the present invention.

In FIG. 9, operation information outputted from, for example, an operation unit of the home server 3 by operating the operation unit thereof by a user, and sensor information (events notification) outputted from various sorts of sensors are inputted to the home server 3, and then, are received by the application program 29 on the home server 3. In order to input the above-described operation information to the home server 3, the below-mentioned manners may be utilized: That is, a manner by which, for example, the home server 3 has a Web server function, and a user interface is provided by the HTML (Hyper Text Markup Language) may be utilized; a manner by which while a TV on the home network 1 is utilized, a user interface is provided from this TV with respect to the home server 3 by utilizing the UPnP may be utilized; and other manners may be utilized.

In order to utilize the former manner, a Web browser must be installed in a terminal for displaying the user interface. In order to utilize the latter method, the client programs (31, 33, 35) for controlling the application program 29 is required on the side of the TV. Also, such a function for providing the user interface through the UPmP to other terminals (information processing apparatuses (5, 7, 9) and the like) is required for the application program 29.

When the operation information made by the user and the notification of the events from these various sorts of sensors are received, the application program 29 checks the apparatus management table 27. Then, the application program 29 analyzes that an upper grade service desired by the user corresponds to any one of the services registered in the apparatus management table 27 based upon the operation information made by the user, the contents of the event notification, the information processing apparatus corresponding to the notification destination, and the like (step S111).

When the upper grade service requested by the user is revealed, or such an upper grade service is revealed which is judged to be required since the event occurs, the application program 29 checks whether or not such an information processing apparatus required to execute the upper grade service is present on the home network 1. This checking operation is carried out with respect to the information processing apparatus having the unique ID registered in the unique ID registering area 75 of the application management table 27 (step S112).

As a result of the above-described checking operation, when the application program 29 confirms that the above-described information process apparatus can be utilized, the upper grade service desired by the user is performed. On the other hand, as a result of the above-described checking operation, if the above-described information processing apparatus can be utilized, then the application program 29 verifies whether or not such a service executable only by an exclusively required function held by each of the information processing apparatuses can be provided with respect to the user. As a consequence, the service can be provided only by such an information processing apparatus which can be utilized only when the event occurs.

A detailed explanation as to contents of services which can be provided to the user by the information processing apparatuses (5, 7, 9) on the home network 1 will be omitted. For instance, with respect to the monitoring services registered in the service content registering area 65 shown in FIG. 4 to FIG. 6, in such a case that a Web camera, an HDD recorder, or an NAS is present on the home network 1 as an information processing apparatus, since these information processing apparatuses are linked to the application program 29 of the home server 3, the below-mentioned service can be provided. That is, a picture about a setting position of this Web camera and a picture about a proximate area of the Web camera, which are photographed by the Web camera, can be continuously stored in the HDD recorder, or the NAS.

Also, in the above-described monitoring services, while human sensible sensors corresponding to one of the information processing apparatuses are installed at a proximate position of a window and a proximate position of a door in a house, event notification transmitted from the human sensible sensors is received via the application program 29. As a result, the following service may also be provided. That is, for a time duration after the event notification is received until a predetermined time has elapsed, the application program 29 may store thereinto picture information photographed by the Web camera instead of the HDD recorder, or the NAS.

FIG. 10 is an explanatory diagram for indicating an example as to a screen displayed on a display unit of a mobile terminal (mobile apparatus) which is provided in an information processing system according to a second embodiment of the present invention. As the above-described mobile terminal, such a mobile apparatus is employed which is equipped with a wireless transmitting/receiving function, and a touch panel display as a display screen.

While a theater service is registered as the upper grade service in the service content registering area 65 of the apparatus management table 27, in such a case that there are two sets of TVs and two sets of speakers among the information processing apparatuses on the home network 1, a screen 121 shown in FIG. 10 is displayed/outputted onto the display unit of the above-described mobile terminal. These TVs have receiving functions and reproducing functions of a picture stream, whereas the speakers have receiving functions of a sound stream, and sound outputting functions. While the screen 121 is referred to as a theater service apparatus selection screen, this screen 121 contains a TV selection area 123 for causing the user to select any one of a TV manufactured by a company “A” and another TV manufactured by a company “B”; and a speaker selection area 125 for causing the user to select any one of a speaker manufactured by a company “C” and another speaker manufactured by a company “D.”

In the apparatus management table 27, in such a case that there are plural sets of information processing apparatuses (5, 7, 9) having the same function on the home network 1, unique IDs are registered respectively with respect to plural sets of the information processing apparatuses which have been registered in the information processing apparatus name registering area 67 and are required so as to execute a certain upper grade service registered in the service content registering area 65. In this case, when the user actually utilizes the above-described upper grade service, it is required that the user clarifies her will in such a manner that the user wishes to receive the provision of the above-described service by utilizing any one of these information processing apparatus.

For instance, as described above, in such a case that there are two sets of the TVs having the receiving function and the reproducing function of the picture stream, and the speakers having the receiving function of the sound stream and the sound output function, such a speaker which can be utilized based upon a physical positional relationship can naturally become apparent, depending upon such a fact that the user uses any one of the TVs. However, such a technical means capable of grasping physical positions of the information processing apparatuses (5, 7, 9) positioned in a home is not present on the home network 1. As a consequence, it is required that the user clearly instructs that which speaker is utilized. Thus, in the second embodiment, the mobile terminal having the display unit on which the screen 121 shown in FIG. 10 is displayed is employed as the user interface.

As to apparatus modes functioning as the user interface, any types of apparatuses may be employed if these apparatuses are capable of selecting a desirable information processing apparatus from lists displayed on screens thereof by users. For instance, such a monitor may be employed which has been connected to the home sever 3, and has an operation unit for operating the home server 3. Also, as described in the second embodiment, a mobile terminal may be employed which is equipped with a wireless communication function and a touch panel display on a display screen, since operability by a user is considered.

Alternatively, as explained in the second embodiment, in the case that a mobile terminal is employed, since all of the functions held by the home server 3 may be installed in this mobile terminals, the mobile terminal may function as the home server 3. Furthermore, another mobile terminal may be alternatively equipped with only such a function that operations of an operation unit operated by a user are converted into control commands, and then, the control commands are transmitted to the home server 3. For the sake of simple explanations, the below-mentioned description is made by such an assumption that the functions of the home server 3 have been installed in the mobile terminal. As a consequence, it is so assumed that the apparatus management tale 27 shown in FIG. 6 has also been contained in the above-described mobile terminal.

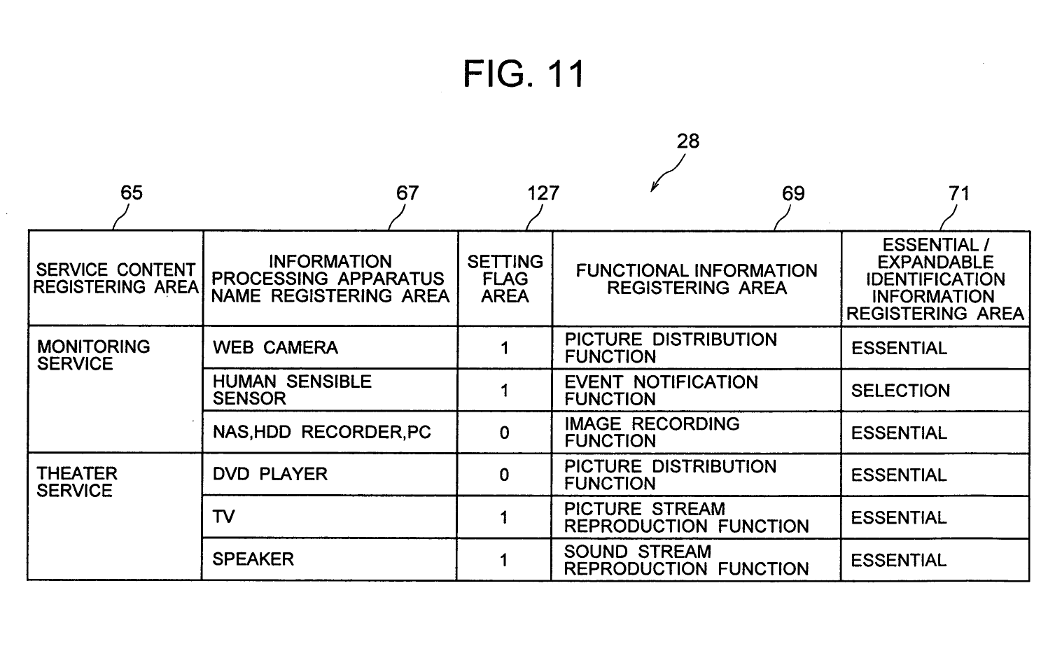

FIG. 11 is an explanatory diagram for representing an example of an apparatus structural table according to the second embodiment of the present invention.

As indicated in FIG. 11, the apparatus structural table 28 related to the second embodiment is different from the apparatus structural table 25 shown in FIG. 4 with respect to such a point that a setting flag area 127 is newly provided. Since other structurals of the apparatus structural table 28 are identical those shown in FIG. 4, the same reference numerals shown in FIG. 4 will be employed as those for denoting the same structural elements indicated in FIG. 11, and thus, detailed explanations thereof will be omitted.

In the second embodiment, a theater service is newly registered as the upper grade service in the service content registering area 65. Moreover, various sorts of information as to an information processing apparatus name, a function, essential/expandable identification information, setting flags “ON/OFF”, and the like are registered in the information processing apparatus name registering area 67, the function information registering area 69, the essential/expandable identification information registering area 71, and the setting flag area 127, respectively.

To the setting flag area 127, “1 (namely, ON)” is set with respect to an information processing apparatus which is required by being set by the user, whereas “0 (namely, OFF)” is set with respect to an information processing apparatus which is not required by being set by the user, respectively. In this second embodiment, it is so assumed that the setting flags “ON/OFF” have been previously set, depending upon sorts of information processing apparatuses having the apparatus structural table (28).

In the example shown in FIG. 11, the setting flag “ON” has been set to a Web camera; the setting flag “ON” has been set to a human sensible sensor; and the setting flags “OFF” have been set to an NAS, an HDD recorder, and a PC, which are related to a monitoring service. Also, the setting flag “OFF” has been set to a DVD player; the setting flag “ON” has been set to a TV; and the setting flag “ON” has been set to a speaker, which are related to a theater service.

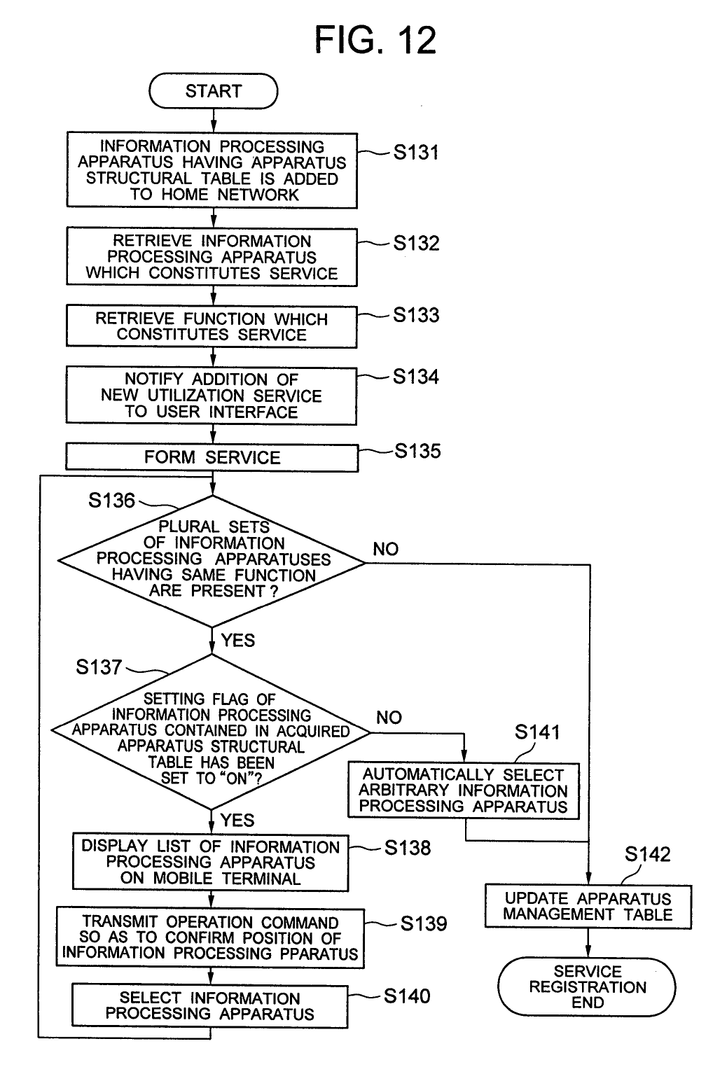

FIG. 12 is a flow chart for indicating process sequences executed when the user receives a provision of a theater service from the information processing system according to the second embodiment by employing the mobile terminal having the display screen shown in FIG. 10 as the user interface.

In FIG. 12, firstly, the information processing apparatuses (5, 7, 9) having the previously described apparatus structural tables 25 are added (connected) on the home network 1 (step S131). Next, when an initial setting operation for the theater service is carried out, the user retrieves the information processing apparatuses (5, 7, 9) located on the home network 1 via the mobile terminal (screen 121 shown in FIG. 10) (step S132). As a result of this retrieving operation, when such an information processing apparatus required for executing the theater service is found out (step S133), such a message that the theater service is available is notified via the user interface (display screen 121 shown in FIG. 10) to the user (step S134), and further, information related to the retrieved information processing apparatus is temporarily registered in the apparatus management table 27 (step S135).

Next, when this information is registered in the apparatus management table 27, a check is made whether or not plural sets of in information processing apparatuses having the same functions are present on the home network 1 (step S136). As a result of this checking operation, if there are plural sets of the information processing apparatuses having the same functions on the home network 1 (“YES” in step S136), then the mobile terminal acquires the apparatus structural tables 28 from these information processing apparatuses so as to check whether or not the flags “ON” have been registered in the setting flag regions 127 contained in these apparatus structural tables 28 (step S137). As a result of this checking operation, if the flags “ON” have been registered in the setting flag areas 127 contained in the apparatus structural tables 28 (“YES” in step S137), then a list of the information processing apparatus (theater service apparatus selection screen 121 shown in FIG. 10) is displayed on the display unit of the mobile terminals (step S138).

Since the user operates the operation unit of the mobile terminal, operation commands are transmitted with respect to the information processing apparatuses related to the execution of the above-described theater service, and then, since these operation commands are received, if responses to the mobile terminal from these information processing apparatuses are received, then setting positions of these information processing apparatus are confirmed via the mobile terminal (step S139). Next, when the user selects a specific information processing apparatus from the plural sets (whose functions are overlapped with each other) of information processing apparatuses which are displayed in the list form on the display unit of the mobile terminal (step S140), a simple user interface used to operate this specific information processing apparatus is displayed on the display unit. For example, in such a case that a list of TVs is being displayed as the information processing apparatuses whose functions are overlapped with each other, if the user selects a certain TV from the list, then a button of the power supply of the TV is displayed which may be turned ON/OFF at a time when this TV is selected; and if the user depresses this button, then the power supply of the selected TV is turned ON/OFF. Other than the ON/OFF operation of the power supply, the above-described button operation may be similarly applied to a channel operation, a sound volume control operation, and an operation for reproducing a test stream. As to any of these operations, such a condition capable of judging that a TV being presently operable correspond to any one of these TVs constitutes an initial condition. The above-described button operation may be similarly applied to such a case that a list of speakers as the information processing apparatuses whose functions are overlapped with each other is being displayed on the display unit of the mobile terminal. Thus, the user may select any one speaker from the plural sets of speakers described in the list form, and may confirm that this selected speaker is controllable via the mobile terminal.

When an information processing apparatus to be used is defined by being selected by the user (“NO” in step S136), such a theater service which will be registered in the apparatus management table 27 (service content registering area 65 thereof) contained in the mobile terminal is again registered in this apparatus management table as a theater service which is performed by the TV and the speaker which are selected by the user (step S142), and then, the series of process operations is accomplished.

As a result of checking whether or not the flag “ON” has been registered in the setting flag area 127 contained in the apparatus structural table 28, if the flag “ON” has not been registered in the setting flag area 127 (“NO” in step S137), then the mobile terminal executes a process operation for automatically selecting an arbitrary information processing apparatus from the above-described list (step S141), and thereafter, the operation thereof is advanced to the process operation indicated in the step S142.

It should also be noted that the theater service is wanted to be carried out by employing a combination of information processing apparatuses other than the above-explained combination of the information processing apparatuses, the mobile terminal selects new information processing apparatuses via the above-described user interface and performs the same process operation as the above-described process operation.

After the above-described process operations have been accomplished, the user selects the theater service via the mobile terminal, so that the user can utilize the previously set theater service. In the case that such a apparatus called as a light (illumination appliance) is present in the above-described apparatus structural table 25 and brightness of this illumination appliance can be controlled by utilizing the home network 1, the illumination appliance within the room may be automatically controlled to become dark (light-controlled).

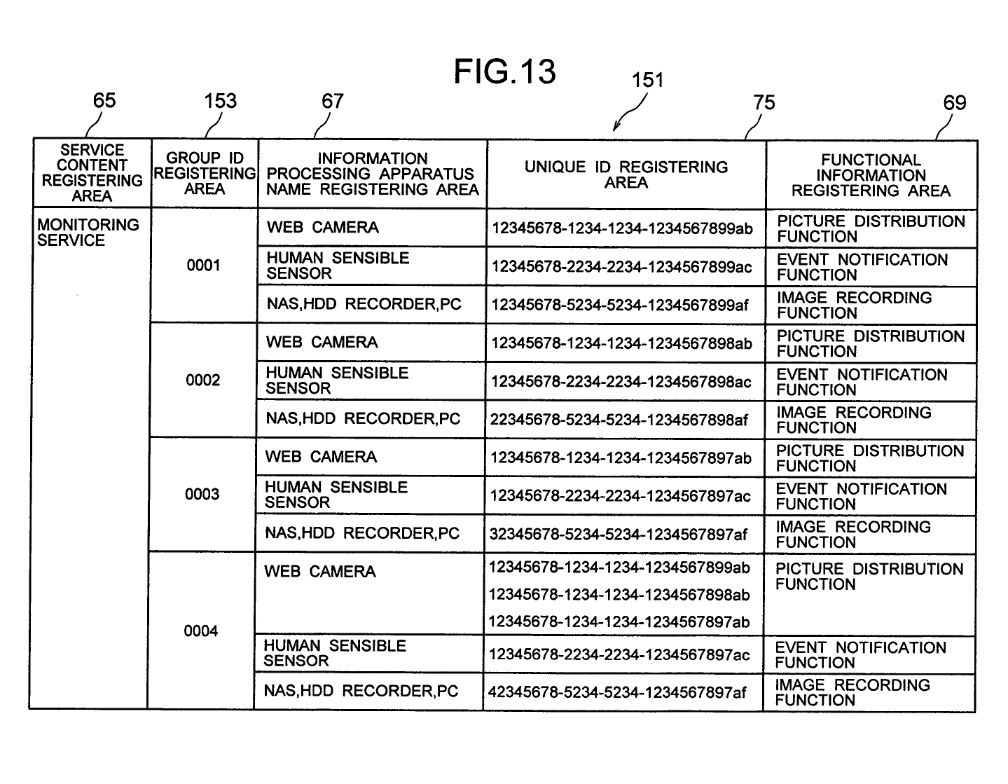

FIG. 13 is an explanatory diagram for indicating an example of an apparatus management table in which a monitoring service has been registered as the upper grade service with respect to the apparatus management table according to the third embodiment of the present invention.

In the case of the monitoring service indicated in FIG. 11, it is conceivable that a plurality of monitoring-purpose Web cameras and a plurality of human sensible sensors are required to be set inside and outside a home, and furthermore, it is conceivable that setting positions of the Web cameras and of the human sensible sensors are required to be grasped. The monitoring service explained in the following description is assumed to contain a process operation in which, for instance, when a human sensible sensor is initiated, a Web camera starts to perform a photographing operation; and a process operation in which photographed picture information is transmitted to a PC having an image recording function, an HDD recorder, and the like.

As apparent with reference to FIG. 13, in the third embodiment, the following case will be described: That is, the service (in this example, monitoring service) which has been registered as the upper grade service in the apparatus management table 151 is provided by a plurality of groups constituted by a plurality of information processing apparatuses related to the above-described service.

In this third embodiment, the above-described monitoring service can be carried out in accordance with the plurality of groups, while each of these groups contains plural sets of information processing apparatuses. As a consequence, group IDs for identifications have been applied to the respective groups. To this end, as shown in FIG. 13, a group ID registering area 153 for registering the respective group IDs has been set to the apparatus management table 151 according to the third embodiment. Since other structures of FIG. 13 are identical to those shown in FIG. 6, the same reference numerals shown in FIG. 6 will be employed as those for denoting the same structures indicated in FIG. 13, and detailed explanations thereof will be omitted.

In the third embodiment, as a group ID, “0001” is applied to such a group constituted by a Web camera having 12345678-1234-1234-1234567899ab as a unique ID; a human sensible sensor having 12345678-2234-2234-1234567899ac as a unique ID; an NAS, an HDD recorder, and a PC, which have 12345678-5234-5234-1234567899af as unique IDs. As a consequence, “0001” is registered as the group ID in the group ID registering area 153 corresponding to the present group.

Next, as a group ID, “0002” is applied to such a group constituted by a Web camera having 12345678-1234-1234-1234567898ab as a unique ID; a human sensible sensor having 12345678-2234-2234-1234567898ac as a unique ID; an NAS, an HDD recorder, and a PC, which have 22345678-5234-5234-1234567898af as unique IDs. As a consequence, “0002” is registered as the group ID in the group ID registering area 153 corresponding to the present group.

Next, as a group ID, “0003” is applied to such a group constituted by a Web camera having 12345678-1234-1234-1234567897ab as a unique ID; a human sensible sensor having 12345678-2234-2234-1234567897ac as a unique ID; an NAS, an HDD recorder, and a PC, which have 32345678-5234-5234-1234567897af as unique IDs. As a consequence, “0003” is registered as the group ID in the group ID registering area 153 corresponding to the present group.

Moreover, as a group ID, “0004” is applied to such a group constituted by a Web camera having 12345678-1234-1234-1234577897ab, 12345678-1234-1234-1234567898ab and 12345678-1234-1234-1234567897ab as unique IDs; a human sensible sensor having 12345678-2234-2234-1234567897ac as a unique ID; an NAS, an HDD recorder, and a PC, which have 423-45678-5234-5234-1234567897af as unique IDs. As a consequence, “0004” is registered as the group ID in the group ID registering area 153 corresponding to the present group.

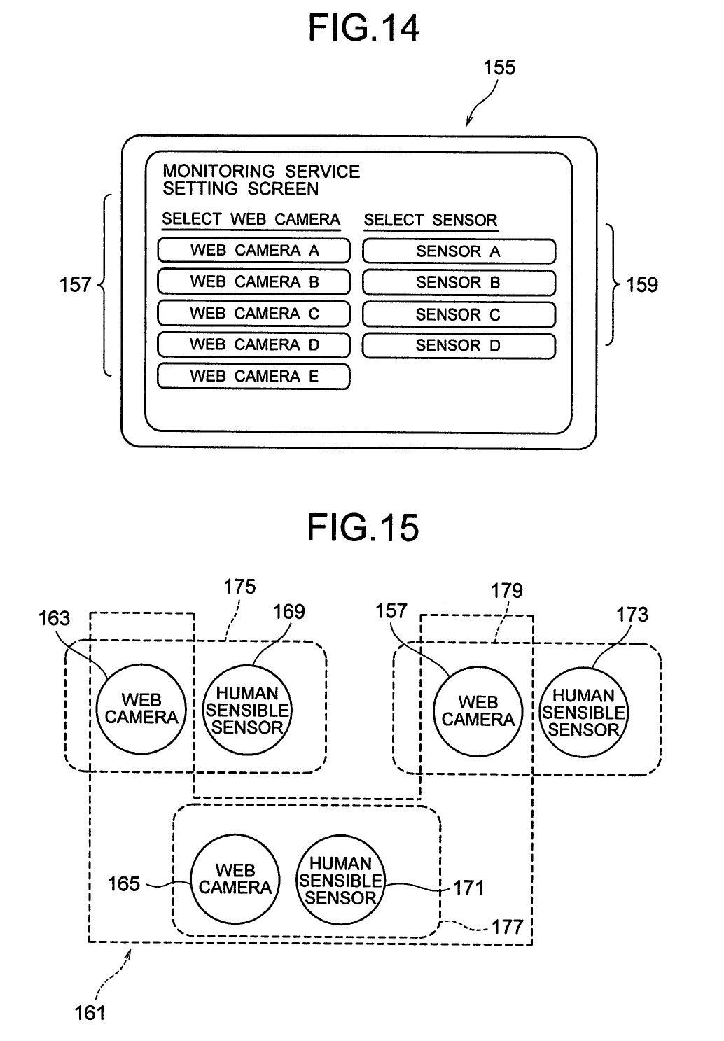

It should be understood that the registering operations of the above-described respective groups IDs “0001, 0002, 0003, and 0004” are carried out via the below-mentioned mobile terminal (shown in FIG. 14) by the user.

FIG. 14 is an explanatory diagram for indicating an example as to a screen displayed on a display unit of a mobile terminal (mobile apparatus) which is provided in the information processing system according to the third embodiment of the present invention. As the above-described mobile terminal, such a mobile apparatus is employed which is equipped with a wireless transmitting/receiving function, and a touch panel display as a display screen, similar to the mobile terminal shown in FIG. 10.

A screen 155 which is displayed/outputted on the display unit of the above-described mobile terminal is called as a “monitoring service setting screen.” The screen 155 contains a Web camera selecting area 157, and a sensor selecting area 159. The Web camera selecting area 157 is provided in order to cause the user to select any one of a Web camera “A”, a Web camera “B”, a Web camera “C”, a Web camera “D”, and a Web camera “E.” The sensor selecting area 159 is provided so as to cause the user to select any one of a sensor “A”, a sensor “B”, and a sensor “C.” Similar to the screen 121 shown in FIG. 10, the screen 155 has a function as a user interface. Since the user depresses a display portion of any one of the Web cameras contained in the Web camera selecting area 157, a Web camera selection signal is outputted from the mobile terminal; and since the user depresses a display portion of any one of the sensors contained in the sensor selecting area 159, a sensor selection signal is outputted from the mobile terminal.

FIG. 15 is a schematic diagram for indicating one example as to a corresponding relationship among the respective information processing apparatuses related to the monitoring service when the monitoring service according to the third embodiment of the present invention is executed.

As represented in FIG. 15, the monitoring service according to the third embodiment has a service area 161 which represents a substantially “ [symbol] ”-shape as an entire area. While Web cameras 163, 165, and 167 are arranged within the service area 161, a human sensible sensor 169 is arranged with the Web camera 163 as a pair; a human sensible sensor 171 is arranged with the Web camera 165 as a pair; and a human sensible sensor 173 is arranged with the Web camera 167 as a pair. The human sensible sensor 169 has a sensing area 175; the human sensible sensor 171 has a sensing area 177; and the human sensible sensor 173 has a sensing area 179.

In FIG. 15, since the human sensible sensor 169 is initiated, picture information photographed by the Web camera 163 is transmitted from the Web camera 163 to the PC having the image recording function; since the human sensible sensor 171 is initiated, picture information photographed by the Web camera 165 is transmitted from the Web camera 165 to the PC having the image recording function; and since the human sensible sensor 173 is initiated, picture information photographed by the Web camera 167 is transmitted from the Web camera 167 to the PC having the image recording function. It should also be noted that when the human sensible sensor 171 is initiated, not only the picture information photographed by the Web camera 165 is transmitted to the above-explained PC, but also the picture information photographed by the Web camera 163 and the picture information photographed by the Web camera 167 are transmitted to the above-described PC, so that such a monitoring service (namely, service area 161) constituted by all of the Web cameras (163, 165, 167) may also be provided.

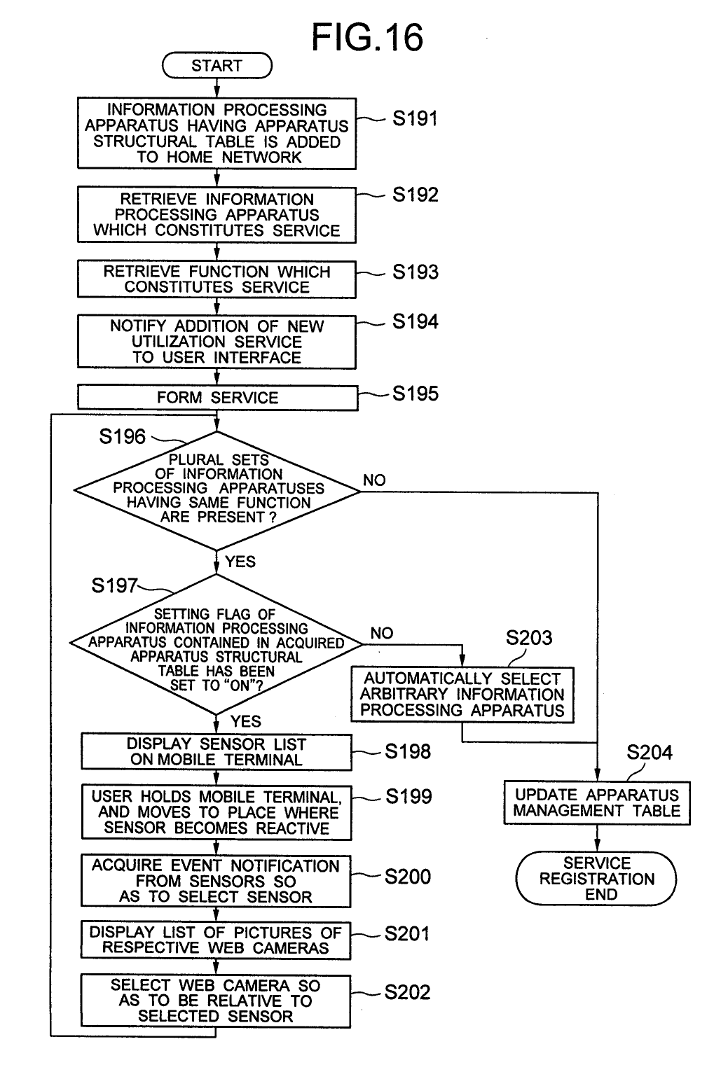

FIG. 16 is a flow chart for indicating process sequences executed when the user receives a provision of a monitoring service from the information processing system according to the third embodiment by employing the mobile terminal having the display screen shown in FIG. 14 as the user interface. In principle, the process sequences shown in FIG. 16 are identical to those indicated in FIG. 12.

In FIG. 16, firstly, the information processing apparatuses (5, 7, 9) having the previously explained apparatus structural tables 25 are added (connected) on the home network 1 (step S191). Next, when an initial setting operation of the monitoring service is carried out, the user retrieves the information processing apparatuses (5, 7, 9) present on the home network 1 via the mobile terminal (screen 155 shown in FIG. 14) (step S192). As a result of this retrieving operation, when such an information processing apparatus required for executing the monitoring service is found out (step S193), such a message that the monitoring service is available is notified via the user interface (display screen 155 shown in FIG. 14) to the user (step S194), and further, information related to the retrieved information processing apparatus is temporarily registered in the apparatus management table 27 (step S195).

Next, when this information is registered in the apparatus management table 27, a check is made whether or not plural sets of in information processing apparatuses having the same functions are present on the home network 1 (step S196). As a result of this checking operation, if there are plural sets of the information processing apparatuses having the same functions on the home network 1 (“YES” in step S196), then the mobile terminal acquires the apparatus structural tables 28 from these plural information processing apparatuses (whose functions are overlapped with each other) so as to check whether or not the flags “ON” have been registered in the setting flag regions 127 contained in these apparatus structural tables 28 (step S197). As a result of this checking operation, if the flags “ON” have been registered in the setting flag areas 127 contained in the apparatus structural tables 28 (“YES” in step S197), then a list of the information processing apparatus (monitoring service apparatus selection screen 155 shown in FIG. 14) is displayed on the display unit of the mobile terminals (step S198).

Next, when the user is moved to a sensing area of any one of the above-described human sensible sensors (169, 171, 173) while the user transports the mobile terminal (step S199), event notification transmitted from any one of the human sensible sensors (169, 171, 173) is received by the mobile terminal. Namely, the above-described sensing area is such an area (175, 177, 179) where any one of the human sensible sensors (169, 171, 173). In this area, a selection of the human sensible sensors (169, 171, 173) is made from the above-explained monitoring service setting screen 155 by the user (step S200). When the selection of the human sensible sensors (169, 171, 173) is carried out by the user, pictures (information) photographed by the respective Web cameras A, B, C, D, E are displayed in a list form in the Web camera selecting area 157 within the monitoring service setting screen 155. When the Web cameras (A, B, C, D, E) are selected, it is required to confirm that such a Web camera to be selected (any one of A, B, C, D, E) is present at which location. As a result, the user reproduces the picture information photographed by the respective Web cameras by employing the above-described user interface (display screen 155 shown in FIG. 14), which are being displayed in the Web camera selecting area 157, and then, selects any one of these Web cameras (A, B, C, D, E) after visually confirming each of the reproduced picture information (step S201).

The user selects a Web camera (any one of A, B, C, D, E) corresponding to the human sensible sensor (any one of 169, 171, 173) selected in the step S200 by referring to the list of the above-described picture (information) (step S202). In other words, in such a case that as previously explained in the apparatus structural table 28 shown in FIG. 11, the setting flags have been applied depending upon various sorts of the registered information processing apparatus (Web cameras), when the human sensible sensors (169, 171, 173) shown in FIG. 15 are initiated, the user is required to select that any one of these Web cameras is operated. When the selection of the Web camera in the step S202 is accomplished, the monitoring service process operation is advanced to the process operation defined in the above-described step S196. If the Web camera (any one of A, B, C, D, E) to be used is defined by the selection by the user (“NO” in step S196), then a monitoring service which is registered in the apparatus management table 27 (namely, service content registering area 55 thereof) contained in the mobile terminal is again registered in this apparatus management table 27 as such a monitoring service which is executed by the human sensible sensor and the Web camera, which are selected by the user. In other words, the apparatus management table 27 provided in the mobile terminal is updated based upon the above-explained process result.

As a consequence, a corresponding relationship among the respective information processing apparatuses related to the monitoring service indicated in FIG. 15 is reflected in the apparatus management table 151 (described in FIG. 13). As previously explained, in the case where the plurality of groups constituted by the plurality of information processing apparatuses related to the same service have been registered in the apparatus management table 151, the group ID registering area 153 is set to this apparatus management table 151 in order to identify the respective groups. Accordingly, when the user wants to utilize the monitoring service via such a user interface as shown in FIG. 14, the user selects any one of the group IDs registered in the group ID registering area 153. As a result, the user can view the picture information which was photographed by the Web camera by initiating the human sensible sensor in the past through the above-described user interface (step S204). After the process operation indicated in the step S204 has been carried out, the series of process operations is accomplished.

As a result of checking whether or not the flag “ON” has been registered in the setting flag area 127 contained in the apparatus structural table 28, if the flag “ON” has not yet been registered in the setting flag area 127 (“NO” in step S197), then the above-described mobile terminal performs such a process operation for automatically selecting arbitrary information processing apparatuses (both human sensible sensor and Web camera) from the list of the above-described information processing apparatuses (step S203), and thereafter, the monitoring service process operation is advanced to a process operation shown in a step S204.

It should also be noted that the user wants to execute the monitoring service by employing a combination of information processing apparatuses other than the above-explained combination of the information processing apparatuses (both human sensible camera and Web camera), the user selects new information processing apparatuses (both human sensible camera and Web camera) via the above-described user interface 155 and performs the same process operation as the above-described process operation.

After the above-described process operations have been accomplished, the user selects the monitoring service via the mobile terminal, so that the user can utilize the previously set monitoring service.

While the preferred embodiments of the present invention have been described, the present invention is not limited only to these embodiments since these embodiments have been merely exemplified. Therefore, the present invention may be alternatively accomplished even based upon various sorts of various embodiment modes.

Other than the above-described embodiments, it is conceivable to realize an information processing system having such an arrangement that the home server 3 is not present on the home network 1. Since the home server 3 is not provided in the alternatively system, apparatus structural tables held by information processing apparatuses provided on the home network 1 are not managed in a batch manner by the home server, but are managed by the respective information processing apparatuses. This may be similarly applied to the apparatus management tables, and the like. Such an information processing apparatus which manages an apparatus structural table by the own processing apparatus may be realized by having the same function as that of a home server. Since a process operation of each of structural units of the above-described information processing system having the above arrangement is similar to that of the above-described information processing system having the home server 3, descriptions thereof will be omitted in the specification.

In the above-described embodiment, various sorts of digital domestic electronic appliances such as an HDD recorder, a PC, a PDA, and a portable telephone are assumed as the information processing apparatus, whereas a PC, an HDD recorder, and the like are assumed as the home server. Also, as to the contents of the process operations described in the above-described embodiment these process operations can be carried out by the middleware installed in the previously listed information processing apparatuses, resulting in good results of design aspects.

It should be further understood by those skilled in the art that although the foregoing description has been made on embodiments of the invention, the invention is not limited thereto and various changes and modifications may be made without departing from the spirit of the invention and the scope of the appended claims.

1. An information processing apparatus for controlling a plurality of information processing apparatuses connected to a communication network, comprising:
a retrieving unit for retrieving said plurality of information processing apparatuses;
apparatus structural table storage means for recording thereinto provision information of a service related to each of said plural information processing apparatuses;
apparatus management table storage means for recording thereinto provision information of a service which is provided by linking said plurality of information processing apparatuses to each other;
an information processing apparatus management information forming unit for forming an apparatus management table based upon a retrieved result of said plurality of information processing apparatuses by said retrieving unit and also the apparatus structural table related to said plurality of information processing apparatuses, said apparatus management table containing a combination of such information processing apparatuses capable of providing a new service different from the services which are separately provided from said respective information processing apparatuses by linking said respective information processing apparatuses to each other; and
an initiation command selecting/outputting unit for selecting an information processing apparatus which is required so as to provide a service from the apparatus management table formed by said information processing apparatus management information forming unit by receiving a service request issued from a user, said provided service corresponding to said service request, and for outputting an initiation command with respect to said selected information processing apparatus.

2. An information processing apparatus as claimed in claim 1 wherein:
when said information processing apparatus itself is connected to said communication network, or another information processing apparatus is connected to said communication network, said retrieving unit retrieves all of the information processing apparatuses which have been connected to said communication network.

3. An information processing apparatus as claimed in claim 1 wherein:
when said information processing apparatus itself is connected to said communication network, or another information processing apparatus is connected to said communication network, said information processing apparatus management information forming unit forms said apparatus management table.

4. An information processing apparatus as claimed in claim 1 wherein:
said apparatus management table is formed with respect to each of identification information which have been previously and separately allocated to all of the information processing apparatuses to be connected to said communication network.

5. An information processing apparatus as claimed in claim 1, further comprising:
a program storage unit for storing thereinto a processing program by which all of the information processing apparatuses connected to said communication network execute a service in response to the service request issued from the user.

6. An information processing apparatus as claimed in claim 1 further comprising:
a judging unit for judging whether or not a plurality of information processing apparatus capable of providing the same service are present among said plurality of information processing apparatuses connected to said communication network, and also, for judging whether or not plural combinations of the information processing apparatuses capable of providing the same service are present; and
an information processing apparatus management information correcting unit by which when said judging unit judges that said information processing apparatuses and the combinations of said information processing apparatuses are present, the apparatus management table formed by said information processing apparatus management information forming unit is corrected as an apparatus management table containing a group ID of each of said combinations; and wherein:
upon receipt of the service request issued from the user and a group designation command issued from the user, said initiation command selecting/outputting unit selects an information processing apparatus required for providing the service corresponding to said service request from said corrected apparatus management table, and outputs an initiation command with respect to said selected information processing apparatus.

7. An information processing apparatus as claimed in claim 6 wherein:
said information processing apparatus management information correcting unit applies a group ID for an identification purpose to a group ID registering area of an apparatus management table provided in correspondence with the group of the information processing apparatuses for providing the service.

8. An information processing system in which a plurality of information processing apparatuses have been connected to a communication network, comprising:
a first information processing apparatus for providing a service to a user; and a second information processing apparatus for controlling said first information processing apparatus; wherein:
said first information processing apparatus is comprised of:
apparatus structural table storage means for recording thereinto provision information of a service related to said information processing apparatus notified to said second information processing apparatus when said first information processing apparatus is connected to said communication network; and wherein:
said second information processing apparatus is comprised of:
a retrieving unit for retrieving a plurality of said first information processing apparatuses connected to said communication network;
apparatus structural table storage means for recording thereinto service provision information of said first information processing apparatus acquired from the retrieved first information processing apparatus;
apparatus management table storage means for recording thereinto provision information of a service which is provided by linking said plurality of first information processing apparatuses to each other;
an information processing apparatus management information forming unit for forming an apparatus management table based upon a retrieved result of said plurality of first information processing apparatuses by said retrieving unit and also the apparatus structural table related to said plurality of first information processing apparatuses, said apparatus management table containing a combination of such information processing apparatuses capable of providing a new service different from the services which are separately provided from said respective information processing apparatuses by linking said respective information processing apparatuses to each other; and
an initiation command selecting/outputting unit for selecting a first information processing apparatus which is required so as to provide a service from the apparatus management table formed by said information processing apparatus management information forming unit by receiving a service request issued from a user, said provided service corresponding to said service request, and for outputting an initiation command with respect to said selected information processing apparatus.

9. An information processing system as claimed in claim 8 wherein:
said communication network is a home network; and
said second information processing apparatus is a home server which instructs each of said information processing apparatuses to provide a service desired by the user.

10. An information processing system as claimed in claim 8 wherein:
said communication network is a home network containing a wireless communication; and,
said second information processing apparatus is a mobile terminal equipped with a wireless function for instructing each of said information processing apparatuses to provide a service desired by the user.

11. An information processing system as claimed in claim 9 wherein:
said first information processing apparatus is a mobile terminal equipped with a wireless function for instructing each of said information processing apparatuses to provide a service desired by the user; and
the service of the user and the selection information of the apparatus are transmitted from said home server to the mobile terminal, and the user operation information is transmitted from said mobile terminal to the home server as a control command.

12. A service providing method of an information processing system in which a plurality of information processing apparatuses have been connected to a communication network, comprising:
a step for detecting that a first information processing apparatus for providing a service to the information processing apparatuses connected to said communication network has been connected to said communication network;
a step for notifying an acquisition request of an apparatus structural table which records thereinto provision information of the service related to the first information processing apparatus from a second information processing apparatus to the first information processing apparatus based upon said detection result;
a step for notifying an apparatus structural table held by said first information processing apparatus to the second information processing apparatus in response to said request; and
a step for judging whether or not said acquired apparatus structural table is a new apparatus structural table, and for storing the acquired apparatus structural table in said second information processing apparatus in such a case that said acquired apparatus structural table is the new apparatus structural table.

13. A service providing method as claimed in claim 12, further comprising:
a step for retrieving an information processing apparatus for constituting a service from the apparatus structural table acquired from a plurality of the first information processing apparatuses connected to the communication network;
a step for retrieving a function which constitutes the service; and
a step for forming an apparatus management table which records thereinto provision information of a service provided by linking said plurality of first information processing apparatuses from said retrieved result.

14. A service providing method as claimed in claim 13, further comprising:
a step in which when a client program for controlling a function is not present, the client program is acquired; and
a step in which when an application program for controlling said client program group is not present, the application program is acquired.

15. A service providing method as claimed in claim 13, further comprising:
a step in which when the same service can be provided to a combination of a plurality of information processing apparatuses as the retrieved result, a group ID is set in correspondence with a group of combining said information processing apparatuses so as to form an apparatus management table.

16. A service providing method as claimed in claim 13, further comprising:
a step in which upon receipt of a service request issued from the user, an information processing apparatus required to provide a service corresponding to said service request from said apparatus management table is displayed; and
a step in which upon receipt of a selection instruction of an information appliance from the user, an initiation command is outputted with respect to the selected information processing apparatus.
